(19) United States
(12) Patent Application Publication
(10) Pub. No.: US 2026/0079748 A1
(43) Pub. Date: Mar. 19, 2026

(54) MEMORY MANAGEMENT TECHNIQUES USING A NON-UNIFORM MEMORY ACCESS MODEL AND A DYNAMIC ASYMMETRIC CPU CORE PROCESSING MODEL

(71) Applicant: Dell Products L.P., Hopkinton, MA (US)

(72) Inventors: Vladimir Shveidel, Pardes-Hana (IL); Lior Kamran, Rishon LeZion (IL); Amitai Alkalay, Kadima (IL)

(73) Assignee: Dell Products L.P., Hopkinton, MA (US)

(21) Appl. No.: 18/885,079

(22) Filed: Sep. 13, 2024

(51) Int. Cl. G06F 9/50

(52) U.S. Cl. CPC G06F 9/5016; G06F 9/5022

(57) ABSTRACT

Techniques can include: performing an initial allocation of memory slices for memory pools from a first memory local to a first socket and a second memory local to a second socket, wherein the initial allocation of memory slices from the first and second memories for each memory pool is based, at least in part, on first information denoting corresponding quantities of CPU cores of the first and second sockets that utilize each memory pool; determining second information including corresponding quantities of CPU cores of the first and second sockets that utilize each memory pool; determining changes between corresponding quantities of CPU cores of the first information and the second information for any of the first socket and the second socket for one or more of the memory pools; and performing dynamic redistribution of memory slices of the one or more memory pools based, at least in part, on the changes.

### BACKGROUND

Systems include different resources used by one or more host processors. The resources and the host processors in the system are interconnected by one or more communication connections, such as network connections. These resources include data storage devices such as those included in data storage systems. The data storage systems are typically coupled to one or more host processors and provide storage services to each host processor. Multiple data storage systems from one or more different vendors can be connected to provide common data storage for the one or more host processors.

A host performs a variety of data processing tasks and operations using the data storage system. For example, a host issues I/O operations, such as data read and write operations, that are subsequently received at a data storage system. The host systems store and retrieve data by issuing the I/O operations to the data storage system containing a plurality of host interface units, disk drives (or more generally storage devices), and disk interface units. The host systems access the storage devices through a plurality of channels provided therewith. The host systems provide data and access control information through the channels to a storage device of the data storage system. Data stored on the storage device is provided from the data storage system to the host systems also through the channels. The host systems do not address the storage devices of the data storage system directly, but rather, access what appears to the host systems as a plurality of files, objects, logical units, logical devices or logical volumes. Thus, the I/O operations issued by the host are directed to a particular storage entity, such as a file or logical device. The logical devices generally include physical storage provisioned from portions of one or more physical drives. Allowing multiple host systems to access the single data storage system allows the host systems to share data stored therein.

### SUMMARY

Various embodiments of the techniques herein can include a computer-implemented method, a system and a non-transitory computer readable medium. The system can include one or more processors, and a memory comprising code that, when executed, performs the method. The non-transitory computer readable medium can include code stored thereon that, when executed, performs the method. The method can comprise: performing, at a first point in time, an initial allocation of memory slices for a plurality of memory pools from a first memory and a second memory, wherein the first memory is i) local to, and directly accessed by, CPU cores of a first socket and ii) remotely accessed by CPU cores of a second socket, and wherein the second memory is i) local to, and directly accessed by, CPU cores of the second socket and ii) remotely accessed by CPU cores of the first socket, wherein the initial allocation of memory slices from the first memory and the second memory for each of the plurality of memory pools is based, at least in part, on first information including: i) a first quantity of CPU cores of the first socket that handle one or more workflow types associated with said each memory pool and that utilize said each memory pool and ii) a second quantity of CPU cores of the second socket that handle one or more workflow types associated with said each memory pool and that utilize said each memory pool; determining second information at a second point in time subsequent to the first point in time, wherein the second information includes, for each of the plurality of memory pools at the second point in time, i) a third quantity of CPU cores of the first socket that handle one or more workflow types associated with said each memory pool and that utilize said each memory pool, and ii) a fourth quantity of CPU cores of the second socket that handle one or more workflow types associated with said each memory pool and that utilize said each memory pool; determining one or more changes between corresponding quantities of CPU cores of the first information and the second information for any of the first socket and the second socket for one or more of the plurality of memory pools; and performing dynamic redistribution of memory slices of the one or more memory pools based, at least in part, on the one or more changes.

In at least one embodiment, performing dynamic redistribution of memory slices can include performing first processing to dynamically redistribute allocated memory slices of a single memory pool by modifying corresponding proportions of memory slices allocated from each of the first memory and the second memory based, at least in part, on a first change in a number of CPU cores of any of the first socket and the second socket that handles one or more workflow types associated with said single memory pool and that utilize said single memory pool, wherein the single memory pool is included in the one or more memory pools, and wherein the first change is included in the one or more changes. At both the first point in time and the second point in time, the single memory pool can have a same first total of CPU cores of the first socket and the second socket which handle corresponding one or more workflow types associated with said single memory pool and utilize said single memory pool. The first change can denote an increase of a first amount between the first quantity of CPU cores of the first socket at the first point in time and the third quantity of CPU cores of the first socket at the second point in time, and wherein the first change can denote a decrease of the first amount between the second quantity of CPU cores of the second socket at the first point in time and the fourth quantity of CPU cores of the second socket at the second point in time.

In at least one embodiment, the first processing can include: determining whether the first amount exceeds a specified threshold amount of difference; and responsive to determining that the first amount exceeds the specified threshold of difference, performing second processing including: releasing a first number of memory slices of the single memory pool where each of the first number of slices is included in the second memory local to the second socket; and allocating, from the first memory local to the first socket, the first number of additional memory slices for the single memory pool. The first processing can include, responsive to determining that the first amount does not exceed the specified threshold of difference, determining not to dynamically redistribute allocated memory slices of the single memory pool. The second processing can be performed and the first number of slices released from the second memory can be subsequently reallocated to a second of the plurality of memory pools.

In at least one embodiment, the first change can denote a decrease of a first amount between the first quantity of CPU cores of the first socket at the first point in time and the third quantity of CPU cores of the first socket at the second point in time, and wherein the first change can denote an increase of the first amount between the second quantity of CPU cores of the second socket at the first point in time and the fourth quantity of CPU cores of the second socket at the second point in time. The first processing can include: determining whether the first amount exceeds a specified threshold amount of difference; and responsive to determining that the first amount exceeds the specified threshold of difference, performing second processing including: releasing a first number of memory slices of the single memory pool where each of the first number of slices is included in the first memory local to the first socket; and allocating, from the second memory local to the second socket, the first number of additional memory slices for the single memory pool. The first processing can include, responsive to determining that the first amount does not exceed the specified threshold of difference, determining not to dynamically redistribute allocated memory slices of the single memory pool. The second processing can be performed and the first number of slices released from the second memory are subsequently reallocated to a second of the plurality of memory pools.

In at least one embodiment, performing dynamic redistribution of memory slices can include performing first processing to dynamically redistribute allocated memory slices of any of the first memory and the second memory between a first memory pool and a second memory pool, wherein the first memory pool and the second memory pool are included in the one or more memory pools. The one or more changes can include a first reduction, between the first point in time and the second point in time, in CPU cores of the first socket that handle one or more workflow types associated with the first memory pool and that utilize the first memory pool, wherein the first reduction can be determined as a difference between one of the respective first quantities of the first information and one of the respective third quantities of the second information corresponding to the first memory pool. The first processing can include releasing, from the first memory pool, a first number of memory slices of the first memory thereby making the first number of memory slices available for reuse and reallocation to another memory pool.

In at least one embodiment, the one or more changes can include a first increase, between the first point in time and the second point in time, in CPU cores of the first socket that handle one or more workflow types associated with the second memory pool and that utilize the second memory pool, wherein the first increase can be determined as a difference between one of the respective first quantities of the first information and one of the respective third quantities of the second information corresponding to the second memory pool. The first processing can include adding, to the second memory pool, a second number of memory slices of the first memory, wherein one or more of the second number of memory slices is included in the first number of memory slices released from the first memory pool. The first number of memory slices released from the first memory pool can be based, at least in part, on the respective third quantity of the second information corresponding to the first memory pool, and wherein the second number of memory slices added to the second memory pool can be based, at least in part, on the respective third quantity of the second information corresponding to the second memory pool.

In at least one embodiment, processing can include: prior to performing said initial allocation of memory slices at the first point in time, determining a plurality of partitions of CPU cores for the plurality of memory pools, wherein each of the plurality of memory pools is associated with a corresponding one of the plurality of partitions, where CPU cores of said corresponding one partition are used exclusively for handling one or more workflow types that are associated with said each memory pool and that access said each memory pool, and wherein, for each of the plurality of memory pools, the corresponding one of the plurality of partitions can have a total number of CPU cores equal to a sum of a respective one of the first quantities and a respective one of the second quantities corresponding to said each memory pool.

### BRIEF DESCRIPTION OF THE DRAWINGS

Features and advantages of the present disclosure will become more apparent from the following detailed description of exemplary embodiments thereof taken in conjunction with the accompanying drawings in which:

FIG. 1 is an example of components that can be included in a system in accordance with the techniques of the present disclosure.

FIG. 2A is an example illustrating the I/O path or data path in connection with processing data in an embodiment in accordance with the techniques of the present disclosure.

FIGS. 2B, 2C and 2D are examples illustrating use of a log in at least one embodiment in accordance with the techniques of the present disclosure.

FIG. 3 is an example of CPU sockets, memories, and connections that can be included in at least one embodiment of a system in accordance with the techniques of the present disclosure.

FIG. 4 is an example illustrating partitioning memories into slices in at least one embodiment in accordance with the techniques of the present disclosure.

FIG. 5 is an example illustrating types or classes of structures and corresponding workflows in at least one embodiment in accordance with the techniques of the present disclosure.

FIG. 6 is an example illustrating initial CPU core distributions per socket for corresponding memory pools and workflow types or classifications in at least one embodiment in accordance with the techniques of the present disclosure.

FIG. 7 is an example illustrating information that can be collected periodically to determine the CPU core distributions per socket for corresponding memory pools and associated workflow types or classifications in at least one embodiment in accordance with the techniques of the present disclosure.

FIGS. 8A and 8B are flowcharts of processing steps that can be performed in at least one embodiment in accordance with the techniques of the present disclosure.

### DETAILED DESCRIPTION OF EMBODIMENT(S)

A system, such as a data storage system, can implement and use different models in connection with various resources, such as CPU and memory. In at least one embodiment, a system in accordance with the techniques of the present disclosure can implement and use an asymmetric CPU core processing model, where CPU cores can be divided into partitions or subsets, and where each such partition or subset can be dedicated to perform processing for a single particular task type or workflow type. For example, in a data storage system in at least one embodiment, workflow types can include: i) user I/O and ii) background (BG) flow types. The BG flow type can include BG operations such as, for example, i) flushing records of a user data (UD) log including recorded operations such as host or client write I/O operations, ii) garbage collection such as in connection with performing garbage collection of back-end (BE) non-volatile storage in a log-structured system (LSS), iii) data deduplication, and possibly other BG operations. In at least one embodiment, the general BG flow type or BG workflow can be further separated into subtypes with corresponding partitions or subsets of dedicated CPU cores for the different BG workflow subtypes. For example, BG workflow subtypes can include i) flush for flush processing or flushing records from the UD log; ii) garbage collection processing for BE non-volatile storage garbage collection in an LSS; and iii) data deduplication processing. In at least one embodiment, separate partitions or subsets of dedicated CPU cores can be further allocated based on the particular BG workflow subtypes such that based on the foregoing 3 BG subtypes, there can be 3 partitions or subsets of dedicated CPU cores corresponding to the 3 BG subtypes.

In at least one embodiment, the CPU core partitioning among the multiple workflow types and/or subtypes into multiple corresponding subsets or partitions can be dynamically performed such that the number of CPU cores assigned to each partition or subset dedicated to each of the particular workflow types, and possibly subtypes, can vary over time. In at least one embodiment CPU core partitioning can be periodically evaluated and modified such as in accordance with the particular workload patterns, and thus the varying workloads of the different workflow types and subtypes. Different I/O workload patterns can generate different burdens on specific workflows and their corresponding partitions of CPU cores. Accordingly in at least one embodiment, the system can vary and adapt the number of CPU cores in each of the partitions or subsets based, at least in part, on the current needs or demands of the various workflows in the system. For example, as the user I/O pace decreases and thus I/O workload decreases, the system can dedicate more CPU cores to a corresponding partition for BG operations or workflow type and can thus decrease the number of dedicated CPU cores in another corresponding partition for user I/O workflow.

In at least one embodiment BG workflows can be further separated into dedicated partitions or subsets with dedicated CPU cores for different BG workflow subtypes. In at least one embodiment, there can be a dedicated partition of CPU cores for flushing or the flush workflow type. In at least one embodiment, each write I/O can be recorded in the UD log (also sometimes referred to simply as a log), where each recorded write I/O of the log can be subsequently flushed from the log. As the number of write I/Os or commands increases, there can also be an increased need and demand for flush processing to flush the log. Thus, the number of CPU cores in a corresponding partition for flush processing can be dynamically increased in response to the increased demand due to the increase in write I/Os recorded in the log.

Different system workflows in a storage system in at least one embodiment can include allocating and reusing multiple different memory resources during the system lifetime. In at least one embodiment, memory resources can be managed in pools, where each pool has a single type of memory resource. A system workflow can request a resource from a relevant pool and then free, release or return the resource back to the same pool when the workflow is complete. Each system workflow can be programmed to request necessary memory resources from corresponding pools and then return the memory resources to the corresponding pools.

In at least one embodiment, a system can include two processor or CPU sockets. A CPU socket, also sometimes referred to simply as a socket, is a physical component on a computer's motherboard that can house a CPU such as a multicore CPU. In at least one embodiment, the storage system can include two sockets, socket 0 and socket 1, where each such socket can include multiple CPU cores. In at least one embodiment, each of the two sockets 0 and 1 can include half the total CPU cores in the system. Each socket can be directly connected to half of the total system memory. The CPU cores can access i) their respective local memory—which is directly connected to the socket the CPU is placed on, and ii) the respective remote memory—which is directly connected to the other remaining socket. In at least one embodiment, access to the remote memory by a CPU core can be achieved using an interconnect between the two sockets.

One memory access model, a uniform memory access (UMA) model, can be used where each pool can be randomly allocated from memories connected to both sockets 0 and 1. With the UMA model, the size of each pool and the particular memories from which portions of the memory pool are allocated can remain the same and may not be dynamically adapted to changing system workloads. Thus using the UMA model can result in potentially a large number of remote memory accesses requiring use of the interconnect. The UMA model can impose a limit on memory bandwidth because the maximum bandwidth of the interconnect to access remote memory can be significantly slower than the maximum bandwidth of a direct connection to local memory. For example in at least one embodiment, the direct memory connection maximum bandwidth can be 256 GBs/second and the interconnect maximum bandwidth when accessing remote memory can be 96 GBs/second. Using the UMA model can also adversely impact workflow latencies since local memory access times are faster than remote memory access times.

In at least one embodiment in accordance with the techniques of the present disclosure, a second different memory access model, a non-uniform memory access (NUMA) model, can be used that allows the system to allocate memory for a memory pool directly connected to a specific socket in order to improve memory access latency and bandwidth. In at least one embodiment in accordance with the techniques of the present disclosure, the NUMA model can be used rather than the above-noted UMA mode that requires allocating both local and remote memory for each memory pool. Put another way, the UMA model can require allocating memory directly connected to both sockets for each memory pool; and the NUMA model can be used to allow allocation of only local memory (e.g., memory that is local with respect to the requesting CPU core and thread executing on such a CPU core) for a memory pool, if desired. For example, assuming the interconnect bandwidth is 96 GBs/second and the direct memory connection is 256 GBs/second, then the maximum bandwidth per socket using the UMA model can be 192 GBs/second (i.e., 2×96 GBs/second-since the memory pool allocation is split between both local and remote memories, the bandwidth is limited to the slower path using the interconnect), while with the NUMA model the maximum bandwidth per socket can be 256 GBs/second.

In at least one embodiment using the NUMA model, job assignment to CPU cores can be non-uniform and dynamic due to the use of a dynamic asymmetric CPU core model as also noted above.

In at least one embodiment of a system using the NUMA model and the dynamic asymmetric CPU core model, providing optimal memory management to achieve maximum memory performance can be non-trivial. For example, consider a system with socket 0 and socket 1, where there are three types of workflows or flows—I/O processing, flush processing, and BG processing. Also assume at a first point in time T1 that all CPU cores of socket 0 are used for processing flush and BG flows and all CPU cores of socket 1 are used for processing I/O flows. One straightforward approach can be to allocate all flush and BG related memory pools only from the local memory 0 of socket 0 and similarly to allocate all I/O related memory pools only from the local memory 1 of socket 1. However, consider a second point in time T2 subsequent to T1. At time T2, the I/O load can be low or decrease relative to the I/O load at T1, and the system may reduce the number of I/O cores in a first partition P1 for I/O processing workflow and may alternatively increase the number of CPU cores in a second partition P2 for BG processing. In connection with the foregoing for example, some CPU cores of socket 1 can be removed from the partition P1 and added to the partition P2 to now be used for BG processing. As a result, a first portion of the BG processing flows corresponding to the partition P2 can now be moved from CPU cores of socket 0 to the added CPU cores on socket 1. The first portion of BG processing flows (e.g., threads) that moved from CPU cores on socket 0 to socket 1 can continue to access memory 0 of socket 0 whereby such memory 0 of socket 0 is now accessed remotely over the interconnect by BG processing flows executing on CPU cores of socket 1. That is the CPU cores on socket 1, which are executing the first portion of moved or relocated BG processing flows, can access memory 0 (that is directly connected to socket 0) over the interconnect. As a result, there can be an increase in memory access time, and thus an adverse impact on the system efficiency and performance.

Accordingly, the techniques of the present disclosure described in the following paragraphs provide a solution for dynamic memory allocation for system memory pools which adapts to different workloads in order to i) reduce the memory access times, ii) increase the potential maximum memory bandwidth, and iii) improve the overall system performance. In at least one embodiment, the techniques of the present disclosure can be used in a storage system using a NUMA model and a dynamic asymmetric CPU model to provide optimal memory management and achieve maximum memory performance. In at least one embodiment, the NUMA model can be used in connection with dynamic redistribution of allocated memory of the memory pools from the various memories local to the corresponding sockets. In at least one embodiment, the dynamic redistribution of memory allocated to the memory pools can be performed periodically based on the different workloads of CPU cores utilizing the various memory pools.

The foregoing and other aspects of the techniques of the present disclosure are described in more detail in the following paragraphs.

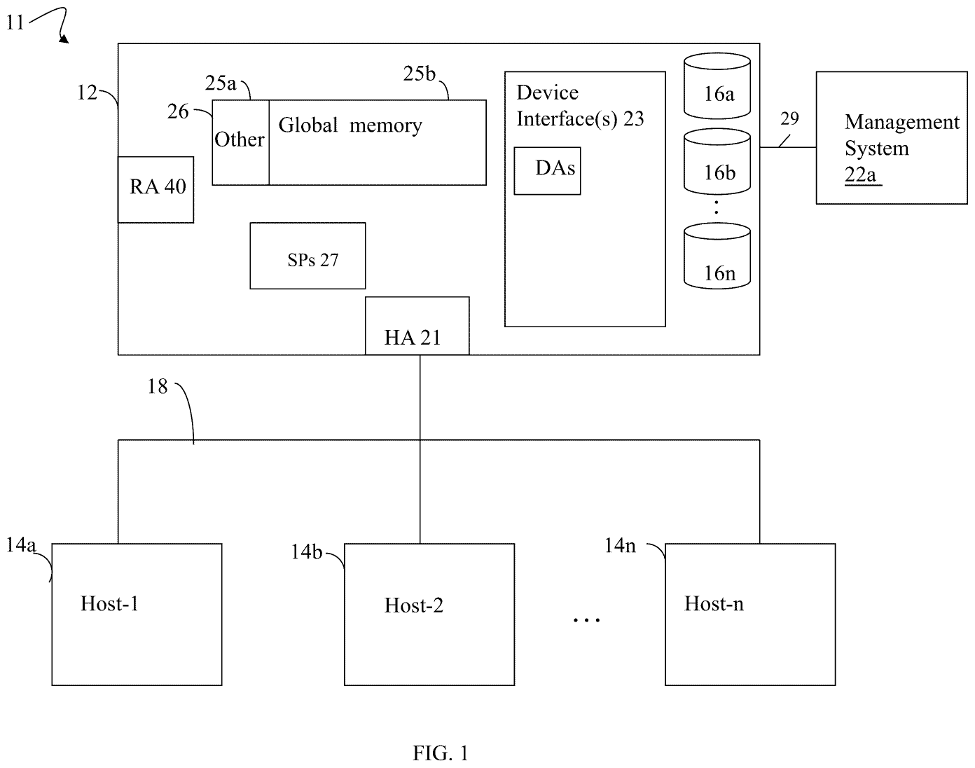

Referring to the FIG. 1, shown is an example of an embodiment of a system 11 that can be used in connection with performing the techniques described herein. The system 11 includes a data storage system 12 connected to the host systems (also sometimes referred to as hosts) 14a-14n through the communication medium 18. In this embodiment of the system 11, the n hosts 14a-14n can access the data storage system 12, for example, in performing input/output (I/O) operations or data requests. The communication medium 18 can be any one or more of a variety of networks or other type of communication connections as known to those skilled in the art. The communication medium 18 can be a network connection, bus, and/or other type of data link, such as a hardwire or other connections known in the art. For example, the communication medium 18 can be the Internet, an intranet, network (including a Storage Area Network (SAN)) or other wireless or other hardwired connection(s) by which the host systems 14a-14n can access and communicate with the data storage system 12, and can also communicate with other components included in the system 11.

Each of the host systems 14a-14n and the data storage system 12 included in the system 11 are connected to the communication medium 18 by any one of a variety of connections in accordance with the type of communication medium 18. The processors included in the host systems 14a-14n and data storage system 12 can be any one of a variety of proprietary or commercially available single or multi-processor system, such as an Intel-based processor, or other type of commercially available processor able to support traffic in accordance with each particular embodiment and application.

It should be noted that the particular examples of the hardware and software that can be included in the data storage system 12 are described herein in more detail, and can vary with each particular embodiment. Each of the hosts 14a-14n and the data storage system 12 can all be located at the same physical site, or, alternatively, can also be located in different physical locations. The communication medium 18 used for communication between the host systems 14a-14n and the data storage system 12 of the system 11 can use a variety of different communication protocols such as block-based protocols (e.g., SCSI (Small Computer System Interface), Fibre Channel (FC), iSCSI), file system-based protocols (e.g., NFS or network file server), and the like. Some or all of the connections by which the hosts 14a-14n and the data storage system 12 are connected to the communication medium 18 can pass through other communication devices, such as switching equipment, a phone line, a repeater, a multiplexer or even a satellite.

Each of the host systems 14a-14n can perform data operations. In the embodiment of the FIG. 1, any one of the host computers 14a-14n can issue a data request to the data storage system 12 to perform a data operation. For example, an application executing on one of the host computers 14a-14n can perform a read or write operation resulting in one or more data requests to the data storage system 12.

It should be noted that although the element 12 is illustrated as a single data storage system, such as a single data storage array, the element 12 can also represent, for example, multiple data storage arrays alone, or in combination with, other data storage devices, systems, appliances, and/or components having suitable connectivity, such as in a SAN (storage area network) or LAN (local area network), in an embodiment using the techniques herein. It should also be noted that an embodiment can include data storage arrays or other components from one or more vendors. In subsequent examples illustrating the techniques herein, reference can be made to a single data storage array by a vendor. However, as will be appreciated by those skilled in the art, the techniques herein are applicable for use with other data storage arrays by other vendors and with other components than as described herein for purposes of example.

The data storage system 12 can be a data storage appliance or a data storage array including a plurality of data storage devices (PDs) 16a-16n. The data storage devices 16a-16n can include one or more types of data storage devices such as, for example, one or more rotating disk drives and/or one or more solid state drives (SSDs). An SSD is a data storage device that uses solid-state memory to store persistent data. SSDs refer to solid state electronics devices as distinguished from electromechanical devices, such as hard drives, having moving parts. Flash devices or flash memory-based SSDs are one type of SSD that contain no moving mechanical parts. The flash devices can be constructed using nonvolatile semiconductor NAND flash memory. The flash devices can include, for example, one or more SLC (single level cell) devices and/or MLC (multi level cell) devices.

The data storage array can also include different types of controllers, adapters or directors, such as an HA 21 (host adapter), RA 40 (remote adapter), and/or device interface(s) 23. Each of the adapters (sometimes also known as controllers, directors or interface components) can be implemented using hardware including a processor with a local memory with code stored thereon for execution in connection with performing different operations. The HAs can be used to manage communications and data operations between one or more host systems and the global memory (GM). In an embodiment, the HA can be a Fibre Channel Adapter (FA) or other adapter which facilitates host communication. The HA 21 can be characterized as a front end component of the data storage system which receives a request from one of the hosts 14a-n. The data storage array can include one or more RAs used, for example, to facilitate communications between data storage arrays. The data storage array can also include one or more device interfaces 23 for facilitating data transfers to/from the data storage devices 16a-16n. The data storage device interfaces 23 can include device interface modules, for example, one or more disk adapters (DAs) (e.g., disk controllers) for interfacing with the flash drives or other physical storage devices (e.g., PDS 16a-n). The DAs can also be characterized as back end components of the data storage system which interface with the physical data storage devices.

One or more internal logical communication paths can exist between the device interfaces 23, the RAs 40, the HAs 21, and the memory 26. An embodiment, for example, can use one or more internal busses and/or communication modules. For example, the global memory portion 25b can be used to facilitate data transfers and other communications between the device interfaces, the HAs and/or the RAs in a data storage array. In one embodiment, the device interfaces 23 can perform data operations using a system cache included in the global memory 25b, for example, when communicating with other device interfaces and other components of the data storage array. The other portion 25a is that portion of the memory that can be used in connection with other designations that can vary in accordance with each embodiment.

The particular data storage system as described in this embodiment, or a particular device thereof, such as a disk or particular aspects of a flash device, should not be construed as a limitation. Other types of commercially available data storage systems, as well as processors and hardware controlling access to these particular devices, can also be included in an embodiment.

The host systems 14a-14n provide data and access control information through channels to the storage systems 12, and the storage systems 12 also provide data to the host systems 14a-n through the channels. The host systems 14a-n do not address the drives or devices 16a-16n of the storage systems directly, but rather access to data can be provided to one or more host systems from what the host systems view as a plurality of logical devices, logical volumes (LVs) which are sometimes referred to herein as logical units (e.g., LUNs). A logical unit (LUN) can be characterized as a disk array or data storage system reference to an amount of storage space that has been formatted and allocated for use to one or more hosts. A logical unit can have a logical unit number that is an I/O address for the logical unit. As used herein, a LUN or LUNs can refer to the different logical units of storage which can be referenced by such logical unit numbers. In some embodiments, at least some of the LUNs do not correspond to the actual or physical disk drives or more generally physical storage devices. For example, one or more LUNs can reside on a single physical disk drive, data of a single LUN can reside on multiple different physical devices, and the like. Data in a single data storage system, such as a single data storage array, can be accessed by multiple hosts allowing the hosts to share the data residing therein. The HAs can be used in connection with communications between a data storage array and a host system. The RAs can be used in facilitating communications between two data storage arrays. The DAs can include one or more type of device interface used in connection with facilitating data transfers to/from the associated disk drive(s) and LUN(s) residing thereon. For example, such device interfaces can include a device interface used in connection with facilitating data transfers to/from the associated flash devices and LUN(s) residing thereon. It should be noted that an embodiment can use the same or a different device interface for one or more different types of devices than as described herein.

In an embodiment in accordance with the techniques herein, the data storage system can be characterized as having one or more logical mapping layers in which a logical device of the data storage system is exposed to the host whereby the logical device is mapped by such mapping layers of the data storage system to one or more physical devices. Additionally, the host can also have one or more additional mapping layers so that, for example, a host side logical device or volume is mapped to one or more data storage system logical devices as presented to the host.

It should be noted that although examples of the techniques herein can be made with respect to a physical data storage system and its physical components (e.g., physical hardware for each HA, DA, HA port and the like), the techniques herein can be performed in a physical data storage system including one or more emulated or virtualized components (e.g., emulated or virtualized ports, emulated or virtualized DAs or HAs), and also a virtualized or emulated data storage system including virtualized or emulated components.

Also shown in the FIG. 1 is a management system 22a that can be used to manage and monitor the data storage system 12. In one embodiment, the management system 22a can be a computer system which includes data storage system management software or application that executes in a web browser. A data storage system manager can, for example, view information about a current data storage configuration such as LUNs, storage pools, and the like, on a user interface (UI) in a display device of the management system 22a. Alternatively, and more generally, the management software can execute on any suitable processor in any suitable system. For example, the data storage system management software can execute on a processor of the data storage system 12.

Information regarding the data storage system configuration can be stored in any suitable data container, such as a database. The data storage system configuration information stored in the database can generally describe the various physical and logical entities in the current data storage system configuration. The data storage system configuration information can describe, for example, the LUNs configured in the system, properties and status information of the configured LUNs (e.g., LUN storage capacity, unused or available storage capacity of a LUN, consumed or used capacity of a LUN), configured RAID groups, properties and status information of the configured RAID groups (e.g., the RAID level of a RAID group, the particular PDs that are members of the configured RAID group), the PDs in the system, properties and status information about the PDs in the system, local replication configurations and details of existing local replicas (e.g., a schedule of when a snapshot is taken of one or more LUNs, identify information regarding existing snapshots for a particular LUN), remote replication configurations (e.g., for a particular LUN on the local data storage system, identify the LUN's corresponding remote counterpart LUN and the remote data storage system on which the remote LUN is located), data storage system performance information such as regarding various storage objects and other entities in the system, and the like.

It should be noted that each of the different controllers or adapters, such as each HA, DA, RA, and the like, can be implemented as a hardware component including, for example, one or more processors, one or more forms of memory, and the like. Code can be stored in one or more of the memories of the component for performing processing.

The device interface, such as a DA, performs I/O operations on a physical device or drive 16a-16n. In the following description, data residing on a LUN can be accessed by the device interface following a data request in connection with I/O operations. For example, a host can issue an I/O operation which is received by the HA 21. The I/O operation can identify a target location from which data is read from, or written to, depending on whether the I/O operation is, respectively, a read or a write operation request. The target location of the received I/O operation can include a logical address expressed in terms of a LUN and logical offset or location (e.g., LBA or logical block address) on the LUN. Processing can be performed on the data storage system to further map the target location of the received I/O operation, expressed in terms of a LUN and logical offset or location on the LUN, to its corresponding physical storage device (PD) and address or location on the PD. The DA which services the particular PD can further perform processing to either read data from, or write data to, the corresponding physical device location for the I/O operation.

In at least one embodiment, a logical address LA1, such as expressed using a logical device or LUN and LBA, can be mapped on the data storage system to a physical address or location PA1, where the physical address or location PA1 contains the content or data stored at the corresponding logical address LA1. Generally, mapping information or a mapper layer can be used to map the logical address LA1 to its corresponding physical address or location PA1 containing the content stored at the logical address LA1. In some embodiments, the mapping information or mapper layer of the data storage system used to map logical addresses to physical addresses can be characterized as metadata managed by the data storage system. In at least one embodiment, the mapping information or mapper layer can be a hierarchical arrangement of multiple mapper layers. Mapping LA1 to PA1 using the mapper layer can include traversing a chain of metadata pages in different mapping layers of the hierarchy, where a page in the chain can reference a next page, if any, in the chain. In some embodiments, the hierarchy of mapping layers can form a tree-like structure with the chain of metadata pages denoting a path in the hierarchy from a root or top level page to a leaf or bottom level page.

In at least one embodiment, reading contents stored at a logical address LA1 such as to service a read I/O in response to a read cache miss can including traversing the mapping information of the chain of metadata pages mapping the logical address to a physical location or address of the content of LA1 as stored in BE non-volatile storage.

In at least one embodiment, a write I/O that writes content C1 to LA1 can be persistently recorded, such as in a log discussed elsewhere herein, and then an acknowledgement can be returned to the issuing client. Subsequently, the recorded write I/O can be flushed from the log. Flushing the recorded write I/O can include storing C1 at a physical location or address, and then creating and/or updating corresponding mapping information that maps LA1 the physical location of C1.

It should be noted that an embodiment of a data storage system can include components having different names from that described herein but which perform functions similar to components as described herein. Additionally, components within a single data storage system, and also between data storage systems, can communicate using any suitable technique that can differ from that as described herein for exemplary purposes. For example, element 12 of the FIG. 1 can be a data storage system, such as a data storage array, that includes multiple storage processors (SPs). Each of the SPs 27 can be a CPU including one or more “cores” or processors and each having their own memory used for communication between the different front end and back end components rather than utilize a global memory accessible to all storage processors. In such embodiments, the memory 26 can represent memory of each such storage processor.

Generally, the techniques herein can be used in connection with any suitable storage system, appliance, device, and the like, in which data is stored. For example, an embodiment can implement the techniques herein using a midrange data storage system as well as a high end or enterprise data storage system.

The data path or I/O path can be characterized as the path or flow of I/O data through a system. For example, the data or I/O path can be the logical flow through hardware and software components or layers in connection with a user, such as an application executing on a host (e.g., more generally, a data storage client) issuing I/O commands (e.g., SCSI-based commands, and/or file-based commands) that read and/or write user data to a data storage system, and also receive a response (possibly including requested data) in connection such I/O commands.

The control path, also sometimes referred to as the management path, can be characterized as the path or flow of data management or control commands through a system. For example, the control or management path can be the logical flow through hardware and software components or layers in connection with issuing data storage management command to and/or from a data storage system, and also receiving responses (possibly including requested data) to such control or management commands. For example, with reference to the FIG. 1, the control commands can be issued from data storage management software executing on the management system 22a to the data storage system 12. Such commands can be, for example, to establish or modify data services, provision storage, perform user account management, and the like.

The data path and control path define two sets of different logical flow paths. In at least some of the data storage system configurations, at least part of the hardware and network connections used for each of the data path and control path can differ. For example, although both control path and data path can generally use a network for communications, some of the hardware and software used can differ. For example, with reference to the FIG. 1, a data storage system can have a separate physical connection 29 from a management system 22a to the data storage system 12 being managed whereby control commands can be issued over such a physical connection 29. However in at least one embodiment, user I/O commands are never issued over such a physical connection 29 provided solely for purposes of connecting the management system to the data storage system. In any case, the data path and control path each define two separate logical flow paths.

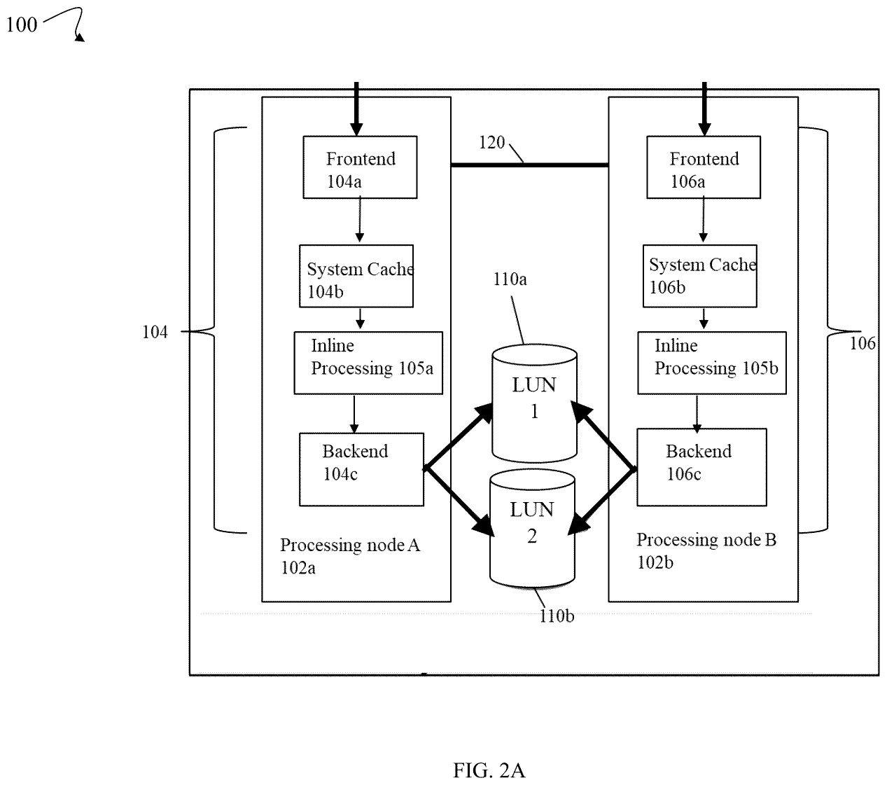

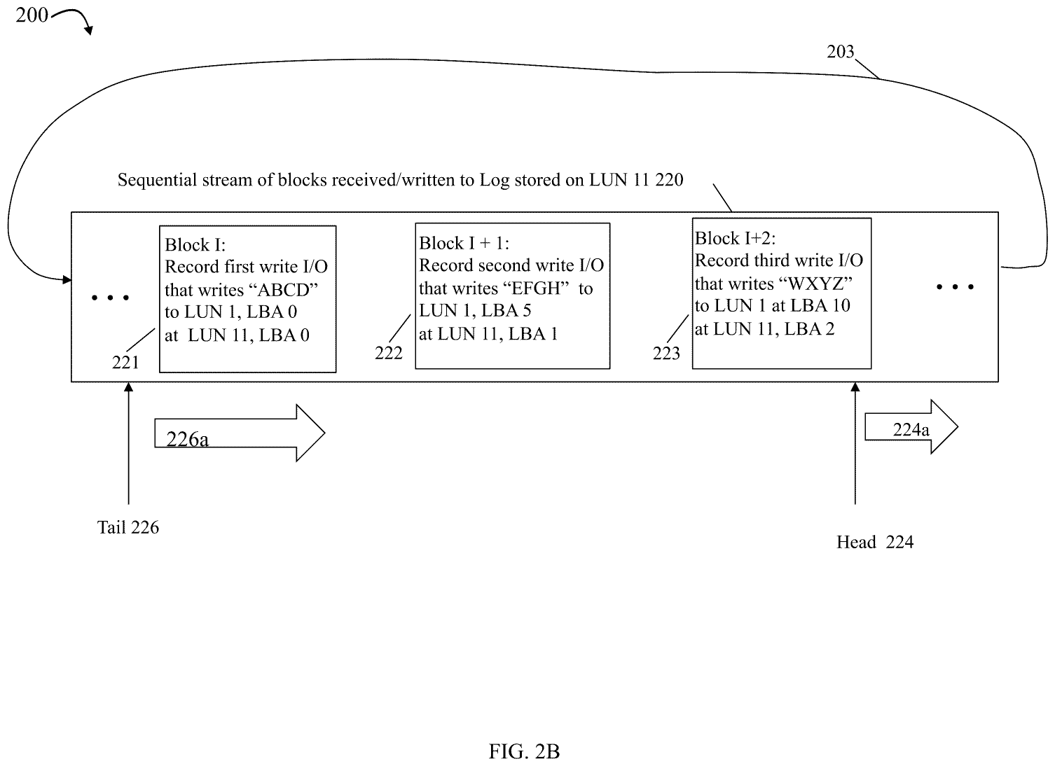

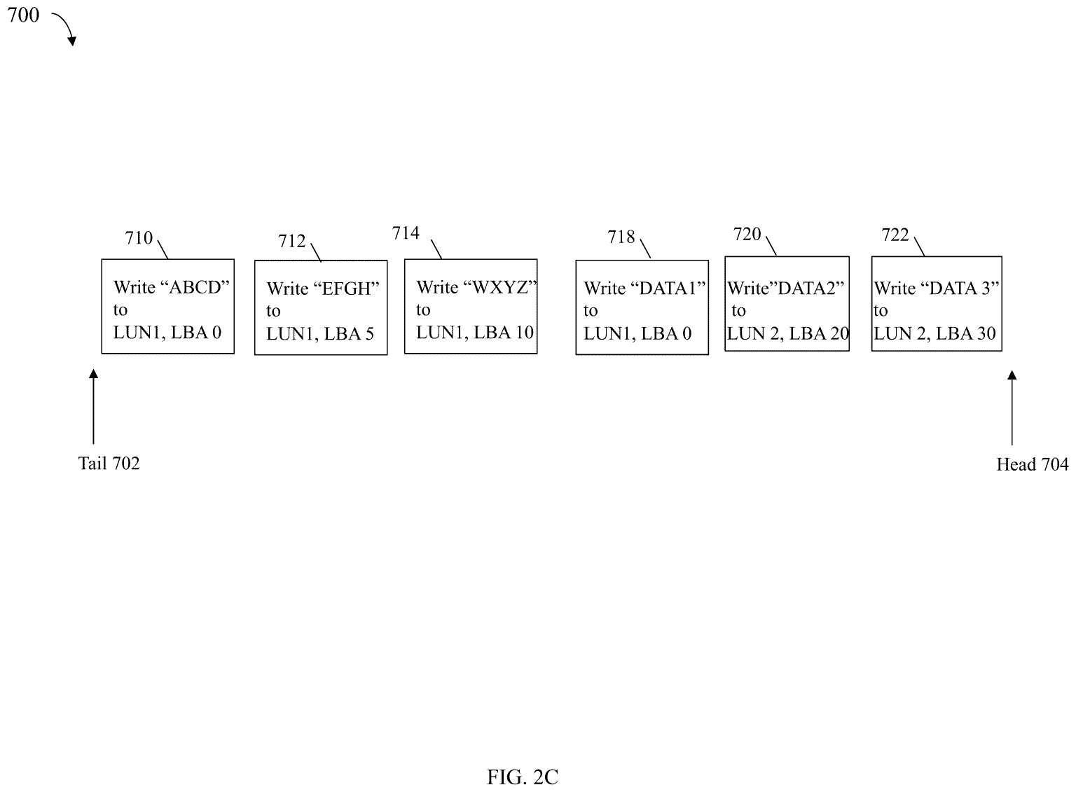

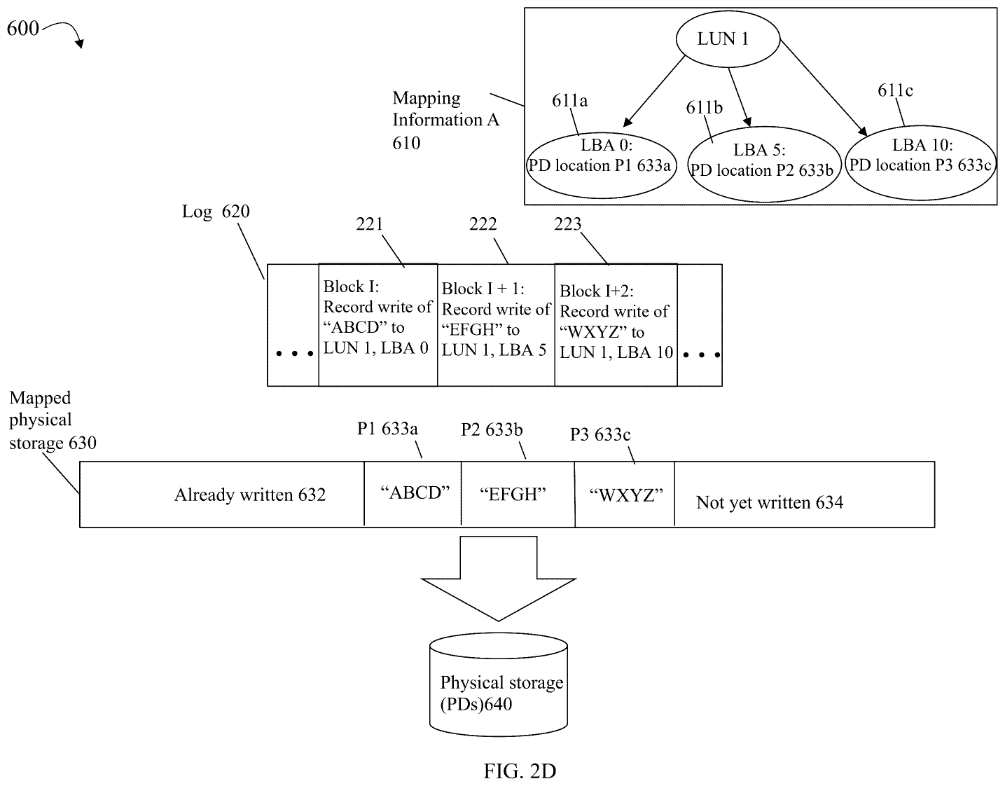

With reference to the FIG. 2A, shown is an example 100 illustrating components that can be included in the data path in at least one existing data storage system in accordance with the techniques herein. The example 100 includes two processing nodes A 102a and B 102b and the associated software stacks 104, 106 of the data path, where I/O requests can be received by either processing node 102a or 102b. In the example 200, the data path 104 of processing node A 102a includes: the frontend (FE) component 104a (e.g., an FA or front end adapter) that translates the protocol-specific request into a storage system-specific request; a system cache layer 104b where data is temporarily stored; an inline processing layer 105a; and a backend (BE) component 104c that facilitates movement of the data between the system cache and non-volatile physical storage (e.g., back end physical non-volatile storage devices or PDs accessed by BE components such as DAs as described herein). During movement of data in and out of the system cache layer 104b (e.g., such as in connection with read data from, and writing data to, physical storage 110a, 110b), inline processing can be performed by layer 105a. Such inline processing operations of 105a can be optionally performed and can include any one of more data processing operations in connection with data that is flushed from system cache layer 104b to the back-end non-volatile physical storage 110a, 110b, as well as when retrieving data from the back-end non-volatile physical storage 110a, 110b to be stored in the system cache layer 104b. In at least one embodiment, the inline processing can include, for example, performing one or more data reduction operations such as data deduplication or data compression. The inline processing can include performing any suitable or desirable data processing operations as part of the I/O or data path.

In a manner similar to that as described for data path 104, the data path 106 for processing node B 102b has its own FE component 106a, system cache layer 106b, inline processing layer 105b, and BE component 106c that are respectively similar to the components 104a, 104b, 105a and 104c. The elements 110a, 110b denote the non-volatile BE physical storage provisioned from PDs for the LUNs, whereby an I/O can be directed to a location or logical address of a LUN and where data can be read from, or written to, the logical address. The LUNs 110a, 110b are examples of storage objects representing logical storage entities included in an existing data storage system configuration. Since, in this example, writes directed to the LUNs 110a, 110b can be received for processing by either of the nodes 102a and 102b, the example 100 illustrates what is also referred to as an active-active configuration.

In connection with a write operation received from a host and processed by the processing node A 102a, the write data can be written to the system cache 104b, marked as write pending (WP) denoting it needs to be written to the physical storage 110a, 110b and, at a later point in time, the write data can be destaged or flushed from the system cache to the physical storage 110a, 110b by the BE component 104c. The write request can be considered complete once the write data has been stored in the system cache whereby an acknowledgement regarding the completion can be returned to the host (e.g., by component the 104a). At various points in time, the WP data stored in the system cache is flushed or written out to the physical storage 110a, 110b.

In connection with the inline processing layer 105a, prior to storing the original data on the physical storage 110a, 110b, one or more data reduction operations can be performed. For example, the inline processing can include performing data compression processing, data deduplication processing, and the like, that can convert the original data (as stored in the system cache prior to inline processing) to a resulting representation or form which is then written to the physical storage 110a, 110b.

In connection with a read operation to read a block of data, a determination is made as to whether the requested read data block is stored in its original form (in system cache 104b or on physical storage 110a, 110b), or whether the requested read data block is stored in a different modified form or representation. If the requested read data block (which is stored in its original form) is in the system cache, the read data block is retrieved from the system cache 104b and returned to the host. Otherwise, if the requested read data block is not in the system cache 104b but is stored on the physical storage 110a, 110b in its original form, the requested data block is read by the BE component 104c from the backend storage 110a, 110b, stored in the system cache and then returned to the host.

If the requested read data block is not stored in its original form, the original form of the read data block is recreated and stored in the system cache in its original form so that it can be returned to the host. Thus, requested read data stored on physical storage 110a, 110b can be stored in a modified form where processing is performed by 105a to restore or convert the modified form of the data to its original data form prior to returning the requested read data to the host.

Also illustrated in FIG. 2A is an internal network interconnect 120 between the nodes 102a, 102b. In at least one embodiment, the interconnect 120 can be used for internode communication between the nodes 102a, 102b.

In connection with at least one embodiment in accordance with the techniques herein, each processor or CPU can include its own private dedicated CPU cache (also sometimes referred to as processor cache) that is not shared with other processors. In at least one embodiment, the CPU cache, as in general with cache memory, can be a form of fast memory (relatively faster than main memory which can be a form of RAM). In at least one embodiment, the CPU or processor cache is on the same die or chip as the processor and typically, like cache memory in general, is far more expensive to produce than normal RAM which can used as main memory. The processor cache can be substantially faster than the system RAM such as used as main memory and contains information that the processor will be immediately and repeatedly accessing. The faster memory of the CPU cache can, for example, run at a refresh rate that's closer to the CPU's clock speed, which minimizes wasted cycles. In at least one embodiment, there can be two or more levels (e.g., L1, L2 and L3) of cache. The CPU or processor cache can include at least an L1 level cache that is the local or private CPU cache dedicated for use only by that particular processor. The two or more levels of cache in a system can also include at least one other level of cache (LLC or lower level cache) that is shared among the different CPUs. The L1 level cache serving as the dedicated CPU cache of a processor can be the closest of all cache levels (e.g., L1-L3) to the processor which stores copies of the data from frequently used main memory locations.

Thus, the system cache as described herein can include the CPU cache (e.g., the L1 level cache or dedicated private CPU/processor cache) as well as other cache levels (e.g., the LLC) as described herein. Portions of the LLC can be used, for example, to initially cache write data which is then flushed to the backend physical storage such as BE PDs providing non-volatile storage. For example, in at least one embodiment, a RAM based memory can be one of the caching layers used as to cache the write data that is then flushed to the backend physical storage. When the processor performs processing, such as in connection with the inline processing 105a, 105b as noted above, data can be loaded from the main memory and/or other lower cache levels into its CPU cache.

In at least one embodiment, the data storage system can be configured to include one or more pairs of nodes, where each pair of nodes can be described and represented as the nodes 102a-b in the FIG. 2. For example, a data storage system can be configured to include at least one pair of nodes and at most a maximum number of node pairs, such as for example, a maximum of 4 node pairs. The maximum number of node pairs can vary with embodiment. In at least one embodiment, a base enclosure can include the minimum single pair of nodes and up to a specified maximum number of PDs. In some embodiments, a single base enclosure can be scaled up to have additional BE non-volatile storage using one or more expansion enclosures, where each expansion enclosure can include a number of additional PDs. Further, in some embodiments, multiple base enclosures can be grouped together in a load-balancing cluster to provide up to the maximum number of node pairs. Consistent with other discussion herein, each node can include one or more processors and memory. In at least one embodiment, each node can include two multi-core processors with each processor of the node having a core count of between 8 and 28 cores. In at least one embodiment, the PDs can all be non-volatile SSDs, such as flash-based storage devices and storage class memory (SCM) devices. It should be noted that the two nodes configured as a pair can also sometimes be referred to as peer nodes. For example, the node A 102a is the peer node of the node B 102b, and the node B 102b is the peer node of the node A 102a.

In at least one embodiment, the data storage system can be configured to provide both block and file storage services with a system software stack that includes an operating system running directly on the processors of the nodes of the system.

In at least one embodiment, the data storage system can be configured to provide block-only storage services (e.g., no file storage services). A hypervisor can be installed on each of the nodes to provide a virtualized environment of virtual machines (VMs). The system software stack can execute in the virtualized environment deployed on the hypervisor. The system software stack (sometimes referred to as the software stack or stack) can include an operating system running in the context of a VM of the virtualized environment. In at least one embodiment, each pair of nodes can be configured in an active-active configuration as described elsewhere herein, such as in connection with FIG. 2A, where each node of the pair has access to the same PDs providing BE storage for high availability. With the active-active configuration of each pair of nodes, both nodes of the pair process I/O operations or commands and also transfer data to and from the BE PDs attached to the pair. In at least one embodiment, BE PDs attached to one pair of nodes is not be shared with other pairs of nodes. A host can access data stored on a BE PD through the node pair associated with or attached to the PD.

In at least one embodiment, each pair of nodes provides a dual node architecture where both nodes of the pair can be identical in terms of hardware and software for redundancy and high availability. Consistent with other discussion herein, each node of a pair can perform processing of the different components (e.g., FA, DA, and the like) in the data path or I/O path as well as the control or management path. Thus, in such an embodiment, different components, such as the FA, DA and the like of FIG. 1, can denote logical or functional components implemented by code executing on the one or more processors of each node. Each node of the pair can include its own resources such as its own local (i.e., used only by the node) resources such as local processor(s), local memory, and the like.

In at least one embodiment, a persisted log can be used for logging user or client operations, such as write I/Os. In at least one embodiment as discussed in more detail elsewhere where herein, the log can also be used to log or record other operations such as operations to create and delete snapshots of storage objects such as volumes or logical devices.

Consistent with other discussion herein, the log can be used to optimize write operation latency. Generally, the write operation writing data is received by the data storage system from a host or other client. The data storage system then performs processing to persistently record the write operation in the log. Once the write operation is persistently recorded in the log, the data storage system can send an acknowledgement to the client regarding successful completion of the write operation. At some point in time subsequent to logging the write or other operation in the log, the write or other operation is flushed or destaged from the log. In connection with flushing the recorded write operation from the log, the data written by the write operation is stored on non-volatile physical storage of a BE PD. The space of the log used to record the write operation that has been flushed can now be reclaimed for reuse. The write operation can be recorded in the log in any suitable manner and can include, for example, recording a target logical address to which the write operation is directed and recording the data written to the target logical address by the write operation. More generally, once an entry of recorded operation of the log is flushed from the log, the log space of the flushed entry can be reclaimed and reused.

In the log in at least one embodiment, each logged operation can be recorded in the next logically sequential record of the log. For example, a logged write I/O and write data (e.g., write I/O payload) can be recorded in a next logically sequential record of the log. The log can be circular in nature in that once a write operation is recorded in the last record of the log, recording of the next write proceeds with recording in the first record of the log.

The typical I/O pattern for the log as a result of recording write I/Os and possibly other information in successive consecutive log records includes logically sequential and logically contiguous writes (e.g., logically with respect to the logical offset or ordering within the log). Data can also be read from the log as needed (e.g., depending on the particular use or application of the log) so typical I/O patterns can also include reads. The log can have a physical storage layout corresponding to the sequential and contiguous order in which the data is written to the log. Thus, the log data can be written to sequential and consecutive physical storage locations in a manner corresponding to the logical sequential and contiguous order of the data in the log. Additional detail regarding use and implementation of the log in at least one embodiment in accordance with the techniques of the present disclosure is provided below.

Referring to FIG. 2B, shown is an example 200 illustrating a sequential stream 220 of operations or requests received that are written to a log in an embodiment in accordance with the techniques of the present disclosure. In this example, the log can be stored on the LUN 11 where logged operations or requests, such as write I/Os that write user data to a file, target LUN or other storage object, are recorded as records in the log. The element 220 includes information or records of the log for 3 write I/Os or updates which are recorded in the records or blocks I 221, I+1 222 and I+2 223 of the log (e.g., where I denotes an integer offset of a record or logical location in the log). The blocks I 221, I+1 222, and I+2 223 can be written sequentially in the foregoing order for processing in the data storage system. The block 221 can correspond to the record or block I of the log stored at LUN 11, LBA 0 that logs a first write I/O operation. The first write I/O operation can write “ABCD” to the target logical address LUN 1, LBA 0. The block 222 can correspond to the record or block I+1 of the log stored at LUN 11, LBA 1 that logs a second write I/O operation. The second write I/O operation can write “EFGH” to the target logical address LUN 1, LBA 5. The block 223 can correspond to the record or block I+2 of the log stored at LUN 11, LBA 2 that logs a third write I/O operation. The third write I/O operation can write “WXYZ” to the target logical address LUN 1, LBA 10. Thus, each of the foregoing 3 write I/O operations logged in 221, 222 and 223 write to 3 different logical target addresses or locations each denoted by a target LUN and logical offset on the target LUN. As illustrated in the FIG. 2B, the information recorded in each of the foregoing records or blocks 221, 222 and 223 of the log can include the target logical address to which data is written and the write data written to the target logical address.

The head pointer 224 can denote the next free record or block of the log used to record or log the next write I/O operation. The head pointer can be advanced 224a to the next record in the log as each next write I/O operation is recorded. When the head pointer 224 reaches the end of the log by writing to the last sequential block or record of the log, the head pointer can advance 203 to the first sequential block or record of the log in a circular manner and continue processing. The tail pointer 226 can denote the next record or block of a recorded write I/O operation in the log to be destaged and flushed from the log. Recorded or logged write I/Os of the log are processed and flushed whereby the recorded write I/O operation that writes to a target logical address or location (e.g., target LUN and offset) is read from the log and then executed or applied to a non-volatile BE PD location mapped to the target logical address (e.g., where the BE PD location stores the data content of the target logical address). Thus, as records are flushed from the log, the tail pointer 226 can logically advance 226a sequentially (e.g., advance to the right toward the head pointer and toward the end of the log) to a new tail position. Once a record or block of the log is flushed, the record or block is freed for reuse in recording another write I/O operation. When the tail pointer reaches the end of the log by flushing the last sequential block or record of the log, the tail pointer advances 203 to the first sequential block or record of the log in a circular manner and continue processing. Thus, the circular logical manner in which the records or blocks of the log are processed form a ring buffer in which the write I/Os are recorded.

When a write I/O operation writing user data to a target logical address is persistently recorded and stored in the non-volatile log, the write I/O operation is considered complete and can be acknowledged as complete to the host or other client originating the write I/O operation to reduce the write I/O latency and response time. The write I/O operation and write data are destaged at a later point in time during a flushing process that flushes a recorded write of the log to the BE non-volatile PDs, updates and writes any corresponding metadata for the flushed write I/O operation, and frees the record or block of the log (e.g., where the record or block logged the write I/O operation just flushed). The metadata updated as part of the flushing process for the target logical address of the write I/O operation can include mapping information as described elsewhere herein. The mapping information of the metadata for the target logical address can identify the physical address or location on provisioned physical storage on a non-volatile BE PD storing the data of the target logical address. The target logical address can be, for example, a logical address on a logical device, such as a LUN and offset or LBA on the LUN.

Referring to FIG. 2C, shown is an example of information that can be included in a log, such as a log of user or client write operations, in an embodiment in accordance with the techniques of the present disclosure.

The example 700 includes the head pointer 704 and the tail pointer 702. The elements 710, 712, 714, 718, 720 and 722 denote 6 records of the log for 6 write I/O operations recorded in the log. The element 710 is a log record for a write operation that writes “ABCD” to the LUN 1, LBA 0. The element 712 is a log record for a write operation that writes “EFGH” to the LUN 1, LBA 5. The element 714 is a log record for a write operation that writes “WXYZ” to the LUN 1, LBA 10. The element 718 is a log record for a write operation that writes “DATA1” to the LUN 1, LBA 0. The element 720 is a log record for a write operation that writes “DATA2” to the LUN 2, LBA 20. The element 722 is a log record for a write operation that writes “DATA3” to the LUN 2, LBA 30. As illustrated in FIG. 2C, the log records 710, 712, 714, 718, 720 and 722 can also record the write data (e.g., write I/O operation payload) written by the write operations. It should be noted that the log records 710, 712 and 714 of FIG. 2C correspond respectively to the log records 221, 222 and 223 of FIG. 2B.

The log can be flushed sequentially or in any suitable manner to maintain desired data consistency. In order to maintain data consistency when flushing the log, constraints can be placed on an order in which the records of the log are flushed or logically applied to the stored data while still allowing any desired optimizations. In some embodiments, portions of the log can be flushed in parallel in accordance with any necessary constraints needed in order to maintain data consistency. Such constraints can consider any possible data dependencies between logged writes (e.g., two logged writes that write to the same logical address) and other logged operations in order to ensure write order consistency.

Referring to FIG. 2D, shown is an example 600 illustrating the flushing of logged writes and the physical data layout of user data on BE PDs in at least one embodiment in accordance with the techniques of the present disclosure. FIG. 2D includes the log 620, the mapping information A 610, and the physical storage (i.e., BE PDs) 640. The element 630 represents the physical layout of the user data as stored on the physical storage 640. The element 610 can represent the logical to physical storage mapping information A 610 created for 3 write I/O operations recorded in the log records or blocks 221, 222 and 223.

The mapping information A 610 includes the elements 611a-c denoting the mapping information, respectively, for the 3 target logical address of the 3 recorded write I/O operations in the log records 221, 222, and 223. The element 611a of the mapping information denotes the mapping information for the target logical address LUN1, LBA 0 of the block 221 of the log 620. In particular, the block 221 and mapping information 611a indicate that the user data “ABCD” written to LUN 1, LBA 0 is stored at the physical location (PD location) P1 633a on the physical storage 640. The element 611b of the mapping information denotes the mapping information for the target logical address LUN1, LBA 5 of the block 222 of the log 620. In particular, the block 222 and mapping information 611b indicate that the user data “EFGH” written to LUN 1, LBA 5 is stored at the physical location (PD location) P2 633b on the physical storage 640. The element 611c of the mapping information denotes the mapping information for the target logical address LUN 1, LBA 10 of the block 223 of the log 620. In particular, the block 223 and mapping information 611 indicate that the user data “WXYZ” written to LUN 1, LBA 10 is stored at the physical location (PD location) P3 633c on the physical storage 640.

The mapped physical storage 630 illustrates the sequential contiguous manner in which user data can be stored and written to the physical storage 640 as the log records or blocks are flushed. In this example, the records of the log 620 can be flushed and processing sequentially (e.g., such as described in connection with FIG. 2B) and the user data of the logged writes can be sequentially written to the mapped physical storage 630 as the records of the log are sequentially processed. As the user data pages of the logged writes to the target logical addresses are written out to sequential physical locations on the mapped physical storage 630, corresponding mapping information for the target logical addresses can be updated. The user data of the logged writes can be written to mapped physical storage sequentially as follows: 632, 633a, 633b, 633c and 634. The element 632 denotes the physical locations of the user data written and stored on the BE PDs for the log records processed prior to the block or record 221. The element 633a denotes the PD location P1 of the user data “ABCD” stored at LUN 1, LBA 1. The element 633b denotes the PD location P2 of the user data “EFGH” stored at LUN 1, LBA 5. The element 633c denotes the PD location P3 of the user data “WXYZ” stored at LUN 1, LBA 10. The element 634 denotes the physical locations of the user data written and stored on the BE PDs for the log records processed after the block or record 223.

In one aspect, the data layout (e.g., format or structure) of the log-based data of the log 620 as stored on non-volatile storage can also be physically sequential and contiguous where the non-volatile storage used for the log can be viewed logically as one large log having data that is layed out sequentially in the order it is written to the log.

The data layout of the user data as stored on the BE PDs can also be physically sequential and contiguous. As log records of the log 620 are flushed, the user data written by each flushed log record can be stored at the next sequential physical location on the BE PDs. Thus, flushing the log can result in writing user data pages or blocks to sequential consecutive physical locations on the BE PDs. In some embodiments, multiple logged writes can be flushed in parallel as a larger chunk to the next sequential chunk or portion of the mapped physical storage 630.

Consistent with other discussion herein, the mapped physical storage 630 can correspond to the BE PDs providing BE non-volatile storage used for persistently storing user data as well as metadata, such as the mapping information.

Thus in at least one embodiment, the data storage system can maintain the user data (UD) or client data, as stored persistently on non-volatile BE storage, as an LSS which can be characterized by not performing in place updates which overwrite existing content. In the LSS for user data, flushing one or more UD log entries of updates to a UD page stored at an existing physical storage location (e.g., on BE PDs) can include determining an updated version of the UD page and storing the updated version of the UD page at a new physical storage location that is different from the existing physical storage location. Thus, the physical storage location of the UD page (as stored persistently on the BE PDs) can move or change each time an updated version of the UD page is written to the BE PDs, where such updated version of the UD page can be the result of flushing one or more entries from the UD log which update the same UD page, and then persistently storing the updated version of the UD page on the BE PDs.

A system, such as a data storage system described herein, can implement and use different models in connection with various resources, such as CPU and memory. In at least one embodiment, a system in accordance with the techniques of the present disclosure can implement and use an asymmetric CPU core processing model, where CPU cores can be divided into partitions or subsets, and where each such partition or subset can be dedicated to perform processing for a single particular task type or workflow type. For example, in a data storage system in at least one embodiment, workflow types can include: i) user I/O and ii) background (BG) flow types. The BG flow type can include BG operations such as, for example, i) flushing records of a user data (UD) log including recorded operations such as host or client write I/O operations, ii) garbage collection such as in connection with performing garbage collection of back-end (BE) non-volatile storage in a log-structured system (LSS), iii) data deduplication, and possibly other BG operations. In at least one embodiment, the general BG flow type or BG workflow can be further separated into subtypes with corresponding partitions or subsets of dedicated CPU cores for the different BG workflow subtypes. For example, BG workflow subtypes can include i) flush for flush processing or flushing records from the UD log; ii) garbage collection processing for BE non-volatile storage garbage collection in an LSS; and iii) data deduplication processing. In at least one embodiment, separate partitions or subsets of dedicated CPU cores can be further allocated based on the particular BG workflow subtypes such that based on the foregoing 3 BG subtypes, there can be 3 partitions or subsets of dedicated CPU cores corresponding to the 3 BG subtypes.

In at least one embodiment, the CPU core partitioning among the multiple workflow types and/or subtypes into multiple corresponding subsets or partitions can be dynamically performed such that the number of CPU cores assigned to each partition or subset dedicated to each of the particular workflow types, and possibly subtypes, can vary over time. In at least one embodiment CPU core partitioning can be periodically evaluated and modified such as in accordance with the particular workload patterns, and thus the varying workloads of the different workflow types and subtypes. Different I/O workload patterns can generate different burdens on specific workflows and their corresponding partitions of CPU cores. Accordingly in at least one embodiment, the system can vary and adapt the number of CPU cores in each of the partitions or subsets based, at least in part, on the current needs or demands of the various workflows in the system. For example, as the user I/O pace decreases and thus I/O workload decreases, the system can dedicate more CPU cores to a corresponding partition for BG operations or workflow type and can thus decrease the number of dedicated CPU cores in another corresponding partition for user I/O workflow.

In at least one embodiment BG workflows can be further separated into dedicated partitions or subsets with dedicated CPU cores for different BG workflow subtypes. In at least one embodiment, there can be a dedicated partition of CPU cores for flushing or the flush workflow type. In at least one embodiment, each write I/O can be recorded in the UD log (also sometimes referred to simply as a log), where each recorded write I/O of the log can be subsequently flushed from the log. As the number of write I/Os or commands increases, there can also be an increased need and demand for flush processing to flush the log. Thus, the number of CPU cores in a corresponding partition for flush processing can be dynamically increased in response to the increased demand due to the increase in write I/Os recorded in the log.

Different system workflows in a storage system in at least one embodiment can include allocating and reusing multiple different memory resources during the system lifetime. In at least one embodiment, memory resources can be managed in pools, where each pool has a single type of memory resource. A system workflow can request a resource from a relevant pool and then free, release or return the resource back to the same pool when the workflow is complete. Each system workflow can be programmed to request necessary memory resources from corresponding pools and then return the memory resources to the corresponding pools.

In at least one embodiment, a system can include two processor or CPU sockets. A CPU socket, also sometimes referred to simply as a socket, is a physical component on a computer's motherboard that can house a CPU such as a multicore CPU. In at least one embodiment, the storage system can include two sockets, socket 0 and socket 1, where each such socket can include multiple CPU cores. In at least one embodiment, each of the two sockets 0 and 1 can include half the total CPU cores in the system. Each socket can be directly connected to half of the total system memory. The CPU cores can access i) their respective local memory—which is directly connected to the socket the CPU is placed on, and ii) the respective remote memory—which is directly connected to the other remaining socket. In at least one embodiment, access to the remote memory by a CPU core can be achieved using an interconnect between the two sockets.

One memory access model, a uniform memory access (UMA) model, can be used where each pool can be randomly allocated from memories connected to both sockets 0 and 1. With the UMA model, the size of each pool and the particular memories from which portions of the memory pool are allocated can remain the same and may not be dynamically adapted to changing system workloads. Thus using the UMA model can result in potentially a large number of remote memory accesses requiring use of the interconnect. The UMA model can impose a limit on memory bandwidth because the maximum bandwidth of the interconnect to access remote memory can be significantly slower than the maximum bandwidth of a direct connection to local memory. For example in at least one embodiment, the direct memory connection maximum bandwidth can be 256 GBs/second and the interconnect maximum bandwidth when accessing remote memory can be 96 GBs/second. Using the UMA model can also adversely impact workflow latencies since local memory access times are faster than remote memory access times.

In at least one embodiment in accordance with the techniques of the present disclosure, a second different memory access model, a non-uniform memory access (NUMA) model, can be used that allows the system to allocate memory for a memory pool directly connected to a specific socket in order to improve memory access latency and bandwidth. In at least one embodiment in accordance with the techniques of the present disclosure, the NUMA model can be used rather than the above-noted UMA mode that requires allocating both local and remote memory for each memory pool. Put another way, the UMA model can require allocating memory directly connected to both sockets for each memory pool; and the NUMA model can be used to allow allocation of only local memory (e.g., memory that is local with respect to the requesting CPU core and thread executing on such a CPU core) for a memory pool, if desired. For example, assuming the interconnect bandwidth is 96 GBs/second and the direct memory connection is 256 GBs/second, then the maximum bandwidth per socket using the UMA model can be 192 GBs/second (i.e., 2×96 GBs/second-since the memory pool allocation is split between both local and remote memories, the bandwidth is limited to the slower path using the interconnect), while with the NUMA model the maximum bandwidth per socket can be 256 GBs/second.

In at least one embodiment using the NUMA model, job assignment to CPU cores can be non-uniform and dynamic due to the use of a dynamic asymmetric CPU core model as also noted above.

In at least one embodiment of a system using the NUMA model and the dynamic asymmetric CPU core model, providing optimal memory management to achieve maximum memory performance can be non-trivial. For example, consider a system with socket 0 and socket 1, where there are three types of workflows or flows—I/O processing, flush processing, and BG processing. Also assume at a first point in time T1 that all CPU cores of socket 0 are used for processing flush and BG flows and all CPU cores of socket 1 are used for processing I/O flows. One straightforward approach can be to allocate all flush and BG related memory pools only from the local memory 0 of socket 0 and similarly to allocate all I/O related memory pools only from the local memory 1 of socket 1. However, consider a second point in time T2 subsequent to T1. At time T2, the I/O load can be low or decrease relative to the I/O load at T1, and the system may reduce the number of I/O cores in a first partition P1 for I/O processing workflow and may alternatively increase the number of CPU cores in a second partition P2 for BG processing. In connection with the foregoing for example, some CPU cores of socket 1 can be removed from the partition P1 and added to the partition P2 to now be used for BG processing. As a result, a first portion of the BG processing flows corresponding to the partition P2 can now be moved from CPU cores of socket 0 to the added CPU cores on socket 1. The first portion of BG processing flows (e.g., threads) that moved from CPU cores on socket 0 to socket 1 can continue to access memory 0 of socket 0 whereby such memory 0 of socket 0 is now accessed remotely over the interconnect by BG processing flows executing on CPU cores of socket 1. That is the CPU cores on socket 1, which are executing the first portion of moved or relocated BG processing flows, can access memory 0 (that is directly connected to socket 0) over the interconnect. As a result, there can be an increase in memory access time, and thus an adverse impact on the system efficiency and performance.

Accordingly, the techniques of the present disclosure described in the following paragraphs provide a solution for dynamic memory allocation for system memory pools which adapts to different workloads in order to i) reduce the memory access times, ii) increase the potential maximum memory bandwidth, and iii) improve the overall system performance. In at least one embodiment, the techniques of the present disclosure can be used in a storage system using a NUMA model and a dynamic asymmetric CPU model to provide optimal memory management and achieve maximum memory performance. In at least one embodiment, the NUMA model can be used in connection with dynamic redistribution of allocated memory of the memory pools from the various memories local to the corresponding sockets. In at least one embodiment, the dynamic redistribution of memory allocated to the memory pools can be performed periodically based on the different workloads of CPU cores utilizing the various memory pools.

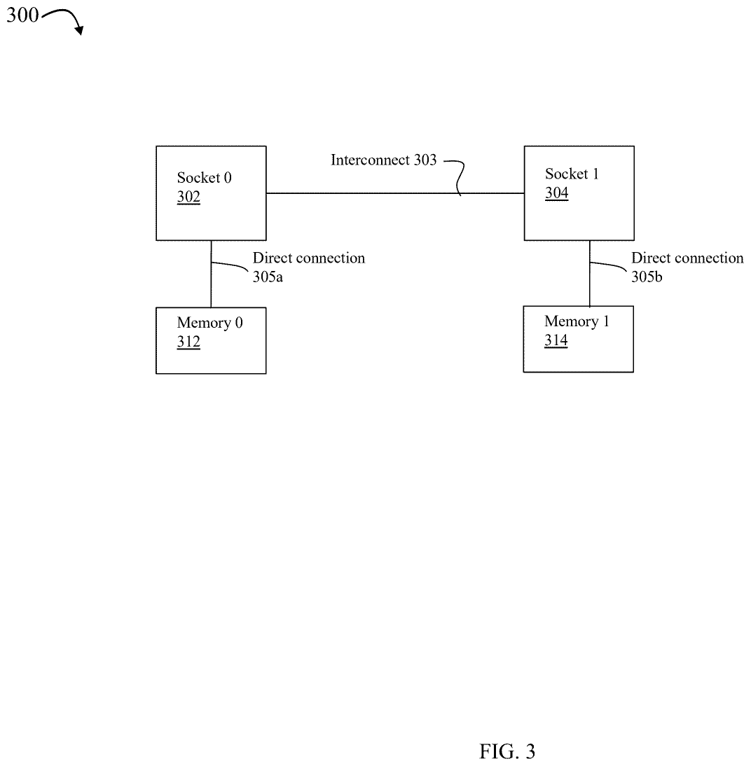

Referring to FIG. 3, shown is an example 300 illustrating CPU sockets and corresponding local memories in at least one embodiment in accordance with the techniques of the present disclosure.

The example 300 includes CPU socket 0 302 and socket 1 304 each including a multicore CPU. In at least one embodiment, each of the CPU sockets 302 and 304 can have half of the total CPU cores in the system. In at least one embodiment of a dual node storage system (e.g., such as illustrated in FIG. 2A), each node can include one of the CPU sockets 302 and 304. For example with reference back to FIG. 2A, socket 0 302 can be included in the node A 102a; and socket 1 304 can be included in the node B 102b.

Memory 0 312 and memory 1 314 can denote the total system memory where each of 312 and 314 can store half the system memory. Thus each of the sockets 302, 304 can be directly connected (e.g., over corresponding connections 305a-b) to half of the total system memory. For example, socket 0 302 can be directly connected, over direct connection 305a, to memory 0 312. The memory 0 312 can be characterized as memory that is local to socket 0 302 such that CPU cores of socket 0 302 can directly access memory 0 312 over the direct connection 305a. In a similar manner, socket 1 304 can be directly connected, over direct connection 305b, to memory 1 314. The memory 1 314 can be characterized as memory that is local to socket 1 304 such that CPU cores of socket 1 304 can directly access memory 1 314 over the direct connection 305b.

The interconnect 303 can be a connection between the CPU sockets 302, 304 and can be used for inter-socket communications. CPU cores of a first socket, such as socket 0 302, can also access memory that is directly connected to the remaining second socket, such as socket 1 304 using the interconnect 303. For example, CPU cores of socket 0 302 can access memory 1 314 using the interconnect 303; and CPU cores of socket 1 304 can access memory 0 312 using the interconnect 303. Thus a CPU core of socket 0 302 can remotely access memory 1 314 over the interconnect 303 and then via the connection 305b; and a CPU core of socket 1 304 can remotely access memory 0 312 over the interconnect 303 and then via the connection 305a.

From the perspective of each socket, CPU cores of the socket can access i) the socket's respective local memory (e.g., directly connected to the socket over a direct connection without using the interconnect 303); and ii) the socket's respective remote memory (e.g., that is directly connected to the other remaining socket and is accessed using a) the interconnect 303 to the other remaining socket, and b) the direct connection between the remaining socket and the remaining socket's local memory).

Consistent with other discussion herein in at least one embodiment, the maximum bandwidth capability of the interconnect 303 can be significantly lower than the maximum bandwidth capability of each of the direct connections 305a-b. For example in at least one embodiment, the maximum bandwidth capability of the interconnect 303 can be 96 GBs/second and the maximum bandwidth capability of each of the direct connections 305a-b can be 256 GBs/second. As a result, local memory access times can generally be faster than remote memory access times.

In at least one embodiment, the techniques of the present disclosure can include classifying memory pools based, at least in part, on the particular workflows or flow types that use and/or allocate memory from the corresponding memory pools. In at least one embodiment, a memory pool can be configured from memory of each socket based, at least in part, on the expectation of how many CPU cores of socket 0 and socket 1 will be involved in the corresponding processing of the workflows or flow types utilizing the memory pool.

In at least one embodiment, the system can move memory between the different pools to enable memory allocation distribution of the pools to dynamically adapt to different workloads over time.

In at least one embodiment, the techniques of the present disclosure can include moving or relocating memory slices of a memory pool from a first memory, that is local to one socket, to a second memory, that is local to a second socket without changing the size or current total capacity of the particular memory pool. In at least one embodiment, the system can move or shift allocated memory of a particular memory pool by changing the proportion or percentage of total memory allocated to the particular memory pool from the different memories local to (e.g., directly connected to) each respective socket.

In at least one embodiment for a particular memory pool, processing can include shifting the proportions of allocated memory between the memories local to corresponding sockets without changing the total capacity or size of the particular memory pool.

In at least one embodiment, the techniques of the present disclosure can include moving memory slices between different memory pools. In at least one embodiment for a particular memory pool, the system can increase and/or decrease the amount of memory allocated from memories local to corresponding sockets that can increase and/or decrease the total capacity or size of the particular memory pool.

The foregoing, as well as other aspects of the techniques of the present disclosure, are described in more detail in the following paragraphs.

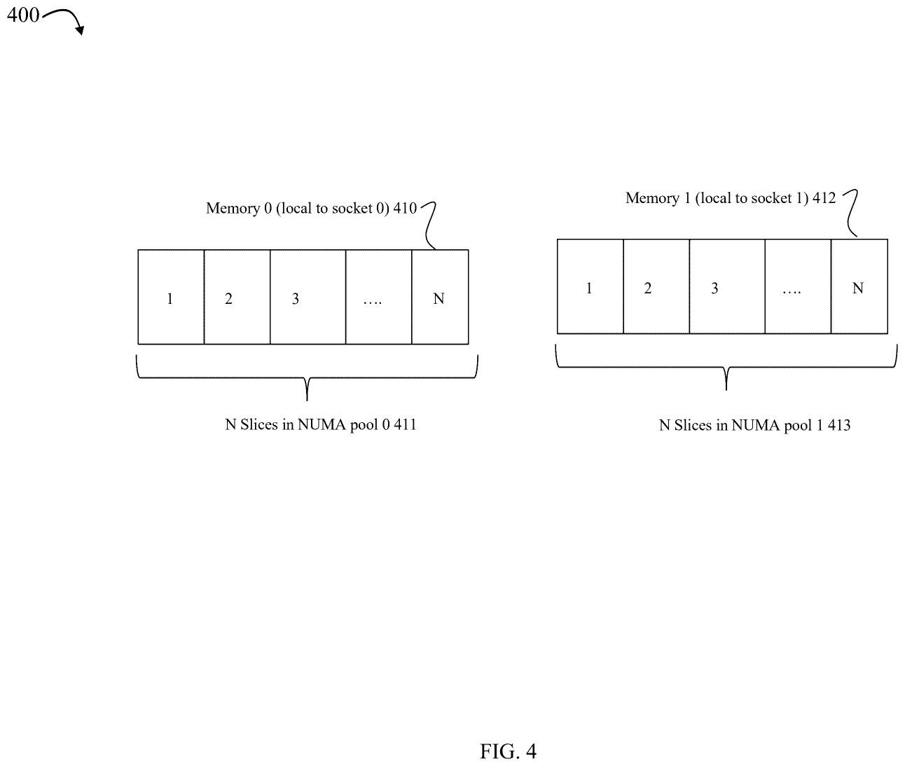

Referring to FIG. 4, shown is an example 400 illustrating the memory portions local to sockets 0 and 1 in at least one embodiment in accordance with the techniques of the present disclosure.

In at least one embodiment, the memory 0 312 and memory 314 of FIG. 3 can be partitioned into large chunks or slices of any suitable size. Element 410 illustrates the partitioning of memory 0 312 into N slices, each of the same slice size such that the N slices of 410 are local and directly accessed by socket 0. The N memory slices local to socket 0 can also be referred to herein as NUMA pool 0 411. Element 412 illustrates the partitioning of memory 1 314 into N slices, each of the same slice size such that the N slices of 412 are local and directly accessed by socket 1. The N memory slices local to socket 1 can also be referred to herein as NUMA pool 1 413.

In at least one embodiment, various memory structures used by the different workflows or flow types can classified based, at least in part, on the particular workflows or flow types that allocate and/or use the structures.

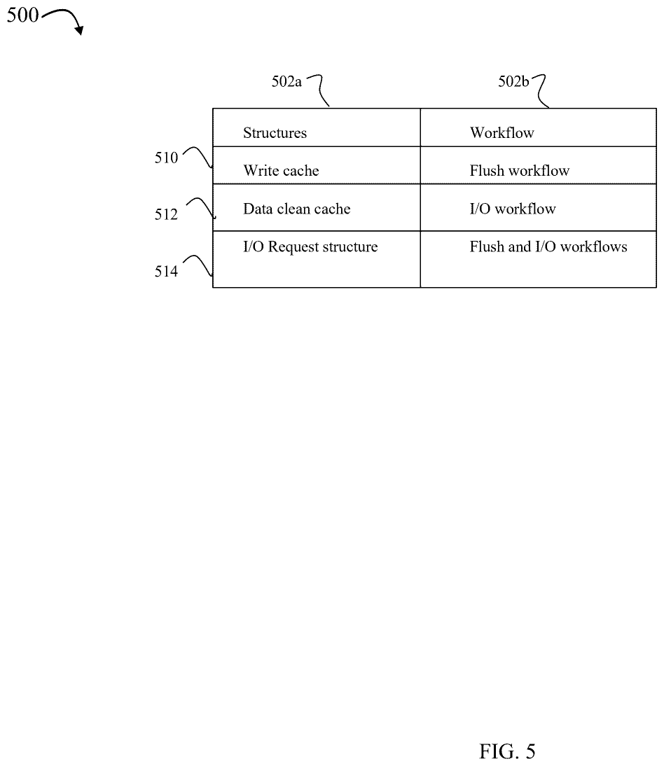

With reference to the example 500 of FIG. 5, consider the following structures and corresponding workflows that can be used in at least one embodiment. It should be noted that the following examples illustrate use of the techniques of the present disclosure with only two workflow types and 3 types or classes of structures. More generally, the techniques of the present disclosure can be used with additional and/or other suitable workflow types and structure classes.

The example 500 includes a table with a first column 502a of memory structures (e.g., classes of memory structures) and a second column 502b of workflow types. Each line or entry of the table identifies the workflow type that generally consumes and/or uses structures of the same entry.

For example, entry 510 indicates that write cache associated structures (502a) can be used exclusively or mainly by flush workflow (502b) type threads and thus CPU cores performing flush workflow processing. Write cache structures can denote those structures associated with caching dirty write data that has not yet been flushed to BE non-volatile storage from the cache. Thus, dirty write data indicates that the write data is the most recently written or up to date content with respect to a corresponding logical address, where the dirty write data denotes a more current or recent version of the content written to the logical address than as stored on BE non-volatile storage. In at least one embodiment, the dirty write data stored in the write cache may remain in the cache until the corresponding write I/O is flushed from the log.

Thus in at least one embodiment, flush threads performing flush workflow processing can be primary consumers of the write cache structures of a write cache memory pool discussed below.

Entry 512 indicates that data clean cache associated structures (502a) can be used mainly by I/O workflow (502b) type threads. Generally, data clean cache structures can be used to store clean data in memory utilized as cache. Data stored at a logical address can be characterized as clean if it is not dirty. Put another way in at least one embodiment, clean cached data is content that is valid data and can be used, for example, to service read requests. However in at least one embodiment, clean cache data can be a candidate for eviction from the cache since the data of the logical address is also persistently stored on the BE PDs.

I/O workflow type threads can perform processing of I/Os received from storage clients, such as external hosts sending I/Os to the storage system. In at least one embodiment, the I/O processing workflow can include processing read I/O operations and write I/O operations received from storage clients. In at least one embodiment, the I/O processing workflow for a read operation can include determining whether the requested read content of a target logical address is stored in cache, such as either in the data clean cache or write cache structures. A cache hit occurs if the read content is in the cache, otherwise a cache miss can result. If there is a cache hit, the I/O workflow processing can retrieve the requested content from the cache and return the content in response to the read I/O. If there is a cache miss in at least one embodiment, the I/O workflow processing can read content of the desired logical address from BE non-volatile storage, store the read content in the data clean cache, and return the requested read content in response to the read I/O.

In at least one embodiment with a log-structured system (LSS), the I/O processing workflow for a write I/O can include persistently recording the write I/O in a log as discussed elsewhere herein and then returning a successful acknowledgement to the issuing client. In at least one embodiment, the I/O processing workflow can also include storing the content written in the write cache structures. At a later point in time, the recorded write I/O of the log can be flushed by a flush workflow type thread to BE non-volatile storage.

In at least one embodiment, the I/O workflow type threads can be a primary consumer of the data clean cache structures (and thus data clean cache memory pool discussed below) such as in connection with read I/O workflow processing.

Entry 514 indicates that I/O request structures (502a) can be used by multiple workflows or flow types (502b). In this example, the I/O request structures can be used by both the flush and I/O workflow types. In at least one embodiment, an I/O request structure can generally be used to provide a context and description of the particular I/O operation processed. Thus in at least one embodiment, flush threads performing flush workflow processing and I/O workflow threads performing I/O workflow processing can both be consumers of the I/O request structures of an I/O request memory pool discussed below.

Processing can be performed to initially create memory pools for the different classes of structures. For example with reference to FIG. 5, processing can be performed to initially create 3 memory pools corresponding to the 3 classes or types of structures denoted by column 502a of lines 510, 512 and 514. In at least one embodiment, processing to create a memory pool can include allocating slices from NUMA pool 0 and/or NUMA pool 1, where such allocated slices are included in the corresponding memory pool. In at least one embodiment, the 3 memory pools can be: the write cache memory pool, the data clean cache memory pool, and the I/O request memory pool; and each of the foregoing 3 memory pools can be used by one or more workflow types such as denoted by column 502b of FIG. 5.

In at least one embodiment, the proportion and/or number of slices allocated from NUMA pool 0 (e.g., memory 0 local to socket 0) and NUMA pool 1 (e.g., memory 1 local to socket 1) for the 3 memory pools can be based, at least in part, on the number of CPU cores of socket 0 and socket 1 involved in the corresponding processing that use structures of such memory pools. Consistent with other discussion herein, each workflow type can be associated with a corresponding partition of CPU cores dedicated to performing processing of the particular workflow type. The number of CPU cores in each such partition associated with a corresponding workflow type can be dynamic and can vary based, at least in part, on the changing workload characteristics of the system. For example, assume initially that 14 CPU cores are included in a first partition PART1 for flush workflow type processing and 15 CPU cores are included in a second partition PART2 for I/O workflow type processing. Also assume initially that the 14 CPU cores of PART1 are all in socket 0 and that all 15 CPU cores of PART2 are in socket 1.

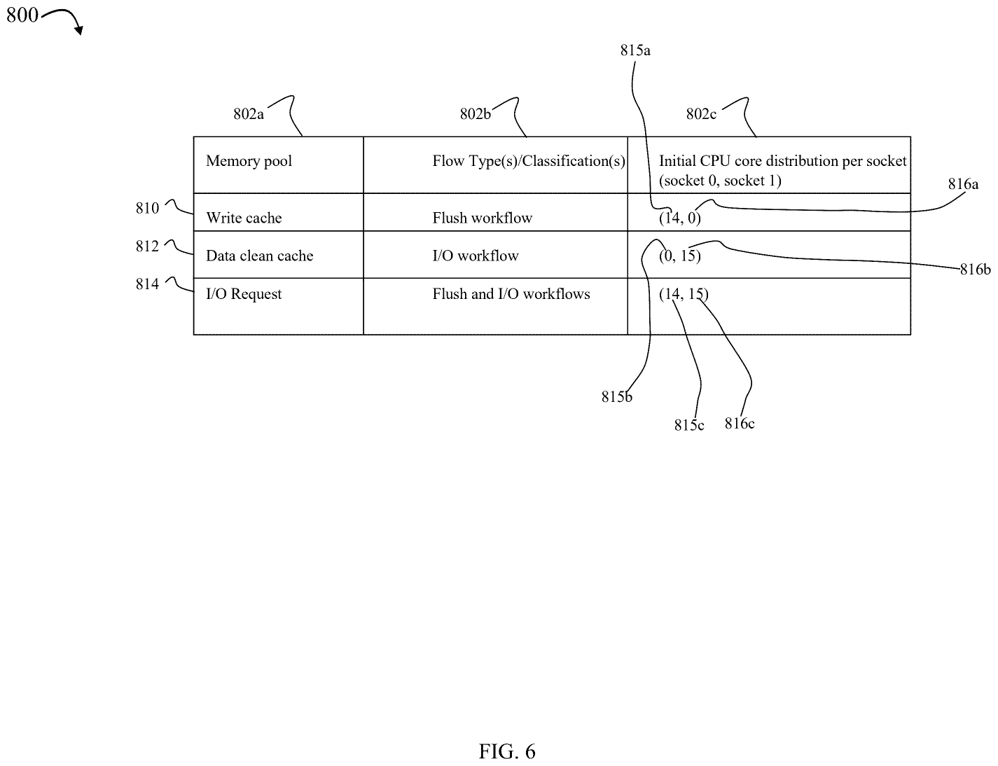

The example 800 of FIG. 6 illustrates the initial CPU core distribution per socket denoting the CPU cores initially expected to consume or use structures of each memory pool in at least one embodiment. The example 800 is based on i) the above-noted 3 memory pools corresponding to the 3 classes or types of structures of 502a of FIG. 5; ii) the corresponding workflow types (e.g., 502b of FIG. 5) that consume or use the 3 memory pools; and iii) the initial CPU partitions PART1 and PART2 noted above. In at least one embodiment, PART1 is a dedicated partition of CPU cores that perform only flush workflow processing, where PART1 has 14 CPU cores from socket 0 and no CPU cores from socket 1; PART 2 is a dedicated partition of CPU cores that perform only I/O workflow processing, where PART2 has 15 CPU cores from socket 1 and no CPU cores from socket 0.

The example 800 includes a table with the following 3 columns: memory pool (802a), flow type(s)/classification(s) (802b), and initial CPU core distribution per socket (802c). Each entry or line of 800 indicates, for a particular memory pool (802a) consumed or used by flow type(s) (802b), the number of CPU cores of each socket expected to consume or use structures of the corresponding memory pool (802a). The example 800 is based on the exemplary assumptions noted above where: 14 CPU cores are included in a first partition PART1 for flush workflow type processing, 15 CPU cores are included in a second partition PART2 for I/O workflow type processing, the 14 CPU cores of PART1 for flush workflow type processing are all in socket 0, and the 15 CPU cores of PART2 for I/O workflow processing are in socket 1.

The line or entry 810 indicates that the write cache memory pool (802a) is used by flush workflow (802b) type threads that execute on CPU cores having a corresponding CPU core distribution per socket (802c). The CPU cores distribution 802c of line 810 denotes the initial per socket distribution of flush workflow type CPU cores that are expected to consume or use structures of the corresponding write cache memory pool. The CPU core distribution per socket 802c of line 810 is “(14,0)”, where 14 denotes the number of CPU cores of socket 0 that are expected to handle the associated flush workflow type (802b) and use the write cache memory pool, and where 0 denotes the number of CPU cores of socket 1 that are expected to handle the associated flush workflow type (802b) and use the write cache memory pool. Generally, a CPU core distribution per socket of column 802c (indicating respective per-socket quantities of CPU cores from socket 0 and socket 1 that handle one or more particular workflow types) can be denoted by a value pair, “(VAL1, VAL2)”, where VAL1 denotes the number or quantity of CPU cores from socket 0 that perform one of the particular workflows, and where VAL2 denotes the number or quantity of CPU cores from socket 1 that perform one of the particular workflows.

The line or entry 812 indicates that the data clean cache memory pool (802a) is used by I/O workflow (802b) type threads that execute on CPU cores having a corresponding CPU core distribution per socket (802c). The CPU core distribution 802c of line 812 denotes the per socket distribution of I/O processing workflow type CPU cores that are expected to consume or use structures of the corresponding data clean cache memory pool. The CPU core distribution per socket 802c of line 812 is “(0,15)”, where 0 denotes the number of CPU cores of socket 0 that are expected to handle the associated I/O processing workflow type (802b) and use the data clean cache memory pool, and wherein 15 denotes the number of CPU cores of socket 1 that are expected to handle the associated I/O processing workflow type (802b) and use the data clean cache memory pool.

The line or entry 814 indicates that the I/O request memory pool (802a) is used by both the I/O workflow and flush workflow (802b) type threads with a corresponding CPU core distribution per socket (802c). The CPU cores 802c of line 814 denotes the per socket distribution of CPU cores expected to consume or use structures of the corresponding I/O request memory pool. The CPU core distribution per socket 802c of line 814 is “(14, 15)”, where 14 denotes the collective quantity of CPU cores of socket 0 collectively expected to handle the associated I/O and flush workflow types (802b) and use the I/O request memory pool, and where 15 denotes the collective quantity of CPU cores of socket 1 expected to handle the associated I/O and flush workflow types (802b and use the I/O request memory pool. In connection with line 814, it should be noted that the distribution of CPU cores 802c expected to consume or use the I/O request memory pool is based on a sum or aggregate of the per socket quantity of CPU cores of the two flow types, I/O and flush workflow types, as denoted by 802b of line 814. For example, “14” (815c) of column 802c line 814 indicates that 14 CPU cores of socket 0 are expected to access the I/O request memory pool where each of the 14 CPU cores of socket 0 perform processing of either the I/O workflow or flush workflow. The foregoing quantity of “14” (815c) is the sum of 14 (815a) and 0 (815b). For example, “15” (816c) of column 802c line 814 indicates that 15 CPU cores of socket 1 are expected to access the I/O request memory pool where each of the 15 CPU cores of socket 1 perform processing of either the I/O workflow or flush workflow. The foregoing quantity of “15” (816c) is the sum of 0 (816a) and 15 (816b).

In at least one embodiment, the CPU core distribution per socket 802c of the memory pools can be used to determine i) the relative proportions or percentages of slices of corresponding memory pools obtained from NUMA pool 0 and NUMA pool 1; and/or ii) the quantity or number of slices of corresponding memory pools obtained from NUMA pool 0 (e.g., memory 0) and NUMA pool 1 (e.g., memory 1). In at least one embodiment, the total number of CPU cores collectively denoted by a CPU core distribution of 802c corresponding to a particular memory pool can be used to determine the total capacity or total number of slices in the particular memory pool. In at least one embodiment, the quantity (e.g., 815a) of CPU cores of a particular socket (e.g., socket 0) that access a corresponding memory pool (e.g., write cache memory pool) can be used to determine the proportion of the total number of slices of the corresponding memory pool obtained from the particular NUMA pool and memory (e.g., NUMA pool 0 and thus memory 0) local to the particular socket (e.g., socket 0). The foregoing is discussed in more detail below.

In at least one embodiment, based on the CPU core distribution 802c of line 810 of the example 800, memory of the write data cache memory pool (802a) can be allocated or assigned all, or a majority of, its slices from NUMA pool 0 (e.g., with none or a small amount of slices allocated or assigned from NUMA pool 1). The foregoing is based, at least in part, on the initial expectation and assignment noted above of all 14 CPU cores handling flush workflow being in socket 0, and no CPU cores from socket 1 handling flush workflow processing.

In at least one embodiment, the quantity or number of slices of the write data cache memory pool obtained from NUMA pool 0 and NUMA pool 1 can be based, at least in part, on the number of CPU cores of each socket handling flush workflow processing. In this example with the write data cache memory pool, it can be assumed that 14 CPU cores of socket 0 can potentially be executing concurrently. In at least one embodiment, the number of slices assigned to the write data cache memory pool from NUMA pool 0 for use by 14 CPU cores can be at least 14 times the amount of write data cache expected to be used by a single write data cache CPU core. Thus in at least one embodiment, the number of CPU cores of a socket can be used as a scaling factor in connection with determining the quantity of memory slices of the socket's local memory to assign or allocate to a memory pool. In at least one embodiment, the larger the number of CPU cores of a particular socket, the larger the number of slices allocated to the memory pool from memory local to the particular socket. In at least one embodiment, the larger the number of CPU cores accessing a particular memory pool, the larger the total capacity and thus total number of slices in the particular memory pool.

In at least one embodiment, based on the CPU core distribution 802c of line 812 of the example 800, memory of the data clean cache memory pool (802a) can be allocated or assigned all, or a majority of, its slices from NUMA pool 1 (e.g., with none or a small amount of slices allocated or assigned from NUMA pool 0. The foregoing is based, at least in part, on the initial expectation and assignment noted above of all 15 CPU cores handling I/O workflow type processing being in socket 1, and no CPU cores from socket 0 handling I/O workflow type processing.

In at least one embodiment, the quantity or number of slices of the data clean cache memory pool obtained from NUMA pool 0 and NUMA pool 1 can be based, at least in part, on the number of CPU cores of each socket handling I/O workflow type processing. In this example with the data clean cache memory pool, it can be assumed that 15 CPU cores of socket 1 can potentially be executing concurrently. In at least one embodiment, the number of slices of NUMA pool 1 assigned to the data clean cache memory pool for use by 15 CPU cores can be at least 15 times the amount of write data cache expected to be used by a single data clean cache CPU core. Thus in at least one embodiment, the number of CPU cores of a socket can be used as a scaling factor in connection with determining the quantity of memory slices of the socket's local memory to assign or allocate to a memory pool. In at least one embodiment, the larger the number of CPU cores of a particular socket, the larger the number of slices allocated to the memory pool from memory local to the particular socket. In at least one embodiment, the larger the number of CPU cores accessing a particular memory pool, the larger the total capacity and thus total number of slices in the particular memory pool.

In at least one embodiment, based on the CPU core distribution 802c of line 814 of the example 800, memory of the I/O request memory pool (802a) can be allocated or assigned its slices from both NUMA pool 0 and NUMA pool 1. In at least one embodiment, the proportion of slices of the I/O request memory pool assigned or allocated from both NUMA pool 0 (e.g., memory 0) and NUMA pool 1 (e.g., memory 1) can be based, at least in part, on i) the number of CPU cores of socket 0 (e.g., 14) expected to access or utilize the I/O request memory pool and ii) the number of CPU cores of socket 1 (e.g., 15) expected to access or utilize the I/O request memory pool. In at least one embodiment, the proportion of slices assigned or allocated from NUMA pool 0 can be based on a first ratio of i) the number of CPU cores of socket 0 (e.g., 14) expected to access or utilize the I/O request memory pool with respect to ii) the sum or aggregate number of CPU cores of socket 0 (e.g., 14) and socket 1 (e.g., 15) expected to access or utilize the I/O request memory pool. For example, in at least one embodiment, 14/29 or about 48% of memory slices of the I/O request memory pool can be from NUMA pool 0 and the remaining 15/29 or about 52% of memory slices of the I/O request memory pool can be from NUMA pool 1.

In at least one embodiment, the quantity or number of slices of the I/O request memory pool obtained from NUMA pool 0 and NUMA pool 1 can be based, at least in part, on the number of CPU cores of each socket handling I/O workflow type processing. In this example with the I/O request memory pool, it can be assumed that 14 CPU cores of socket 0 and 15 CPU cores of socket 1 can potentially be executing concurrently. In at least one embodiment, i) the number of slices of NUMA pool 0 assigned to the I/O request memory pool for use by 14 CPU cores can be at least 14 times the amount of I/O request memory expected to be used by a single flush CPU core; and ii) the number of slices of NUMA pool 1 assigned to the I/O request memory pool for use by 15 CPU cores can be at least 15 times the amount of I/O request memory expected to be used by a single I/O workflow CPU core. Thus in at least one embodiment, the number of CPU cores of a socket can be used as a scaling factor in connection with determining the quantity of memory slices of the socket's local memory to assign or allocate to a memory pool. In at least one embodiment, the larger the number of CPU cores of a particular socket, the larger the number of slices allocated to the memory pool from memory local to the particular socket. In at least one embodiment, the larger the number of CPU cores accessing a particular memory pool, the larger the total capacity and thus total number of slices in the particular memory pool.

In at least one embodiment, an entire application can be configured to run on only CPU cores of a single socket. In at least one embodiment, for the application that only runs on CPU cores of a single socket, memory can be allocated for the application from only the corresponding local memory directly accessed by the single socket. For example, assume an application has corresponding threads that only run on CPU cores of socket 0 302. In at least one embodiment, the memory allocated for use by the application can only be from local memory 312 directly accessed by socket 0 302.

In at least one embodiment, memory such as for a structure used by a thread executing on a CPU core can be allocated in the following manner. Processing can first attempt to allocate the requested memory from the memory that is local with respect to the CPU core, and thus corresponding thread, that made the allocation request. If the local memory allocation request is unsuccessful (e.g., such as because there is insufficient free local memory to fulfill the request), then the memory can be allocated from the remote memory. For example, assume there is a memory allocation request for a thread executing on a CPU core of socket 0 302. Processing can attempt to first allocate the requested memory from memory 312, and thus NUMA pool 0. If the allocation is unsuccessful, then the memory can be allocated from the remote memory 314, and thus NUMA pool 1.

In at least one embodiment, a thread's stack can always be allocated from memory that is local with respect to the CPU core executing the thread. A thread stack is a memory area used by a single thread of execution within a program. Each thread can have its own separate stack, which is used for maintaining the local state of the thread and tracking function calls made by the thread. Memory of a thread's stack can be allocated by the operating system when the thread is created. For example, if a thread TH1 executes on a CPU core of socket 0 302, then in at least one embodiment the techniques of the present disclosure can ensure that memory of the thread TH1's stack is only allocated from memory 312 (and thus NUMA pool 0) that is local to socket 0 302.

Consistent with other discussion herein in at least one embodiment, the role or workflow type processing executed by a CPU core can change constantly based, at least in part, on the particular workload characteristics of the system at various points in time. For example, in response to a large increase or burst in host I/Os received at the storage system, there can be an increase in I/O workflow processing. In response, the system can increase the number of CPU cores in a corresponding partition performing I/O workflow processing, where such CPU cores can be included in any of socket 0 and/or socket 1. As another example, the read/write mixture or ratio of host I/Os can change such that the I/O workload can change from read-heavy to write heavy (e.g., there can be a large increase in the write I/O workload from one or more hosts even though the overall I/O rate (I/Os per second or IOPS) can remain approximately the same). In response, to the increase in write I/O workload, there can be an increase in flush workload. In response, the system can increase the number of CPU cores in a corresponding partition performing flush workflow processing. In a similar manner, the number of CPU cores in a partition can be decreased in response to a decrease in workload and workflow type corresponding to the partition.

In at least one embodiment, the total number of CPU cores in partitions can dynamically change over time due to the changing corresponding workloads. Additionally in at least one embodiment, the distribution of the CPU cores per socket can also change over time as the system makes necessary changes to CPU core partitions in order to adapt to different workloads.

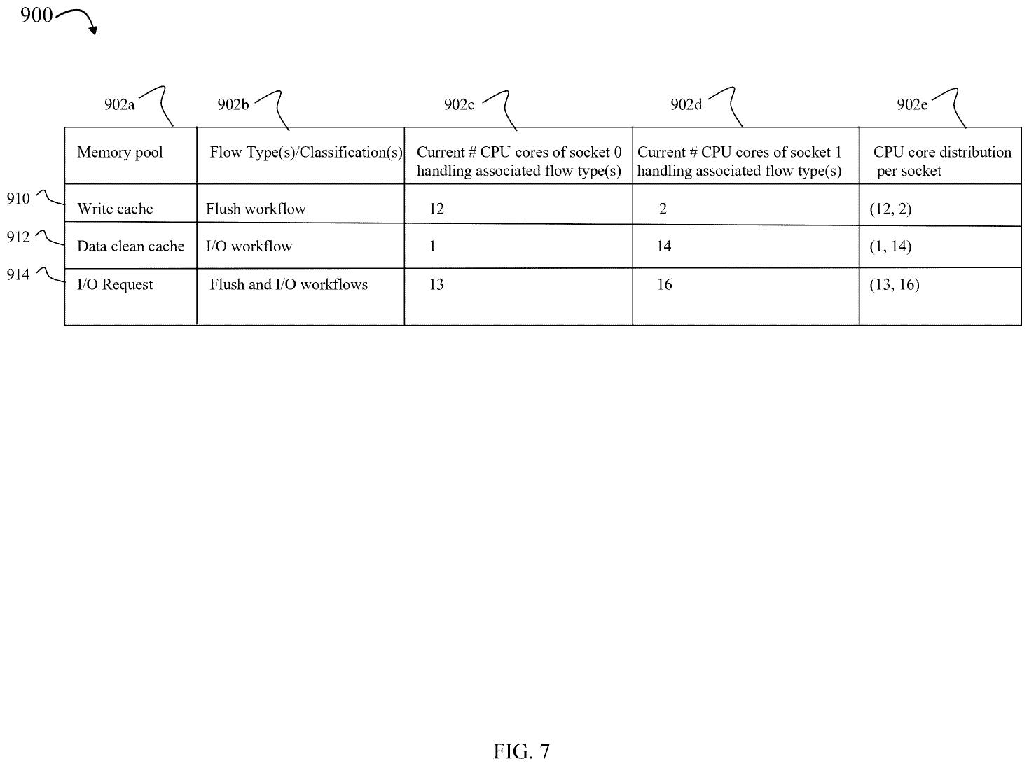

In at least one embodiment in order to further adapt the memory pools to different workloads, the techniques of the present disclosure can perform processing, such as by a memory pool balancer component, which periodically monitors and maintains, for each memory pool, the number of CPU cores of each socket that handles workflows which use the corresponding memory pools such as illustrated in FIG. 7.

For example, reference is made to the example 900 of FIG. 7 illustrating a table of information that can be maintained and used in at least one embodiment in accordance with the techniques of the present disclosure.

The table of 900 includes columns of the following information: memory pool 902a, flow type(s)/classification(s) 902b, current number of CPU cores of socket 0 handling associated flow type(s) 902c, current number of CPU cores of socket 1 handling associated flow type(s) 902d, and CPU core distribution per socket.

Each entry or line of 900 indicates, for a particular memory pool (902a) consumed or used by flow type(s) (902b), the number of CPU cores of socket 0 (902c) consuming or using structures of the corresponding memory pool by handling corresponding flow types, and the number of CPU cores of socket 1 (902d) consuming or using structures of the corresponding memory pool by handling corresponding flow types. Column 902e of each line or entry of 900 collectively shows the CPU core distribution per socket as indicated by columns 902c-d of the same line or entry of 900.

The information of 900 can be collected at another point in time T12 subsequent to the initial or first point in time T1 as discussed above in connection with the initial CPU core distributions per socket as in FIG. 6. Put another way, FIG. 6 illustrates a first state of the CPU core distribution per socket at time T1 and FIG. 7 illustrates a second state of the CPU core distribution per socket at time T12.

In at least one embodiment, the system, such as the memory pool balancer component, can collect information such as in FIG. 7 periodically such as, for example, at the occurrence of each defined time period or cycle. The amount of time of each time period or cycle can generally by any suitable time and can vary with embodiment.

In the example 900 at time T12 based on column 902e of lines 910 and 912, it can be respectively observed that 14 CPU cores are included in a first partition PART1 for flush workflow type processing, and 15 CPU cores are included in a second partition PART2 for I/O workflow type processing. Thus in comparison to time T1 in this example at time T12, the number of CPU cores in each partition PART1 and PART2 is the same at times T1 and T12. However, the distributions of CPU cores per socket for the memory pools 902a has changed.

The line or entry 910 indicates that the write cache memory pool (902a) is used by flush workflow (902b) type threads that execute on CPU cores having a corresponding CPU core distribution per socket (902c). The CPU cores distribution 902c of line 910 denotes, at time T12, the per socket distribution of flush workflow type CPU cores that consume or use structures of the corresponding write cache memory pool. The CPU core distribution per socket 902e of line 910 is “(12, 2)”, where 12 (902c) denotes the number of CPU cores of socket 0 that handle the associated flush workflow type (902b) and use the write cache memory pool, and where 2 (902d) denotes the number of CPU cores of socket 1 that handle the associated flush workflow type (902b) and use the write cache memory pool.

The line or entry 912 indicates that the data clean cache memory pool (902a) is used by I/O workflow (902b) type threads that execute on CPU cores having a corresponding CPU core distribution per socket (902c). The CPU cores distribution 902c of line 912 denotes, at time T12, the per socket distribution of I/O workflow type CPU cores that consume or use structures of the corresponding data clean cache memory pool. The CPU core distribution per socket 902e of line 912 is “(1, 14)”, where 1 (902c) denotes the number of CPU cores of socket 0 that handle the associated I/O workflow type (902b) and use the data clean cache memory pool, and where 14 (902d) denotes the number of CPU cores of socket 1 that handle the associated I/O workflow type (902b) and use the data clean cache memory pool.

The line or entry 914 indicates that the I/O request memory pool (902a) is used by both flush and I/O workflow (902b) type threads that execute on CPU cores having a corresponding CPU core distribution per socket (902c). The CPU cores distribution 902c of line 914 denotes, at time T12, the per socket distribution of I/O and flush workflow type CPU cores that consume or use structures of the corresponding data clean cache memory pool. The CPU core distribution per socket 902e of line 914 is “(13, 16)”, where 13 (902c) denotes the collective number of CPU cores of socket 0 that handle the associated I/O and flush workflow type (902b) and use the I/O request memory pool, and where 16 (902d) denotes the collective number of CPU cores of socket 1 that handle the associated I/O and flush workflow type (902b) and use the I/O request memory pool.

In at least one embodiment, the system can continuously collect information as illustrated in FIG. 7 for each time period N that can be used to dynamically redistribute memory of the memory pools for the next time period N+1.

For example, based on the change in CPU core distribution per socket at times T1 (FIG. 6) and T12 (FIG. 7) for the 3 memory pools (e.g., write cache memory pool, data clean cache memory pool, and I/O request memory pool), the techniques of the present disclosure can move or shift allocated slices of the same memory pool between memory 0 (e.g., NUMA pool 0 local to socket 0) and memory 1 (e.g., NUMA pool 1 local to socket 1). In this example, the total number of slices in each of the 3 pools can remain the same at times T1 and T12 since there has been no change in overall workload or total CPU cores associated with the 3 pools (e.g., partition PART1 corresponding to the flush workflow type has 14 CPU cores at both times T1 and T12, and partition PART2 corresponding to the I/O workflow type has 15 CPU cores at both times T1 and T12). However, at time T12 in at least one embodiment, processing can repartition or redistribute the total number of slices in each memory pool from memories 0 and 1 based, at least in part, on the corresponding current number of CPU cores of sockets 0 and 1. For example, from time T1 (810) to T12 (910), the number of CPU cores of socket 0 handling flush workflows accessing the write data cache memory pool has decreased from 14 to 12, and the number of CPU cores of socket 1 handling flush workflows accessing the write data cache memory pool has increased from 0 to 2.

As a result at time T12 in at least one embodiment for the write cache memory pool, processing can generally move Q1 slices from memory 0 (e.g., NUMA pool 0) to memory 1 (e.g., NUMA pool 1) since the number of CPU cores of socket 1 has increased by 2 and the number of CPU cores socket 0 has accordingly decreased by 2. Put another way, at time T12 as compared to T1, there has been an increase in the number of socket 1 cores accessing the write cache memory pool and there has been a decrease in the number of socket 0 cores accessing the write cache memory pool. In response, the system can release Q1 free slices of memory 0 that are allocated to the write cache memory pool, where such released Q1 free slices are now available for reallocation or reassignment to any memory pool as may be needed. Additionally, the system can assign or allocate Q1 free slices memory 1 to the write cache memory pool. Based on the foregoing, the system has effectively redistributed the total slices allocated to the write cache memory pool among memory 0 and memory 1 based, at least in part, on the current CPU core distribution per socket or change in CPU core distribution per socket between times T1 and T12.

In at least one embodiment, such as discussed below in more detail, a threshold can be defined denoting a minimum amount of change in CPU cores per socket that must be reached prior to performing any reallocation or redistribution of memory slices between memory 0 and 1 within a single memory pool. Thus for example, the threshold can be 4 such that net change (e.g., increase or decrease) in the number CPU cores per socket must be greater than 4 in order to trigger dynamically redistribution allocated slices of memory 0 and memory 1 for a single memory pool. In this scenario, if a threshold of 4 is used and the change in CPU cores per socket (between two points in time such as T1 and T12 as noted above) is 2, the reallocation or redistribution of memory slices allocated from memories 0 and 1 may not be triggered since “2” is not greater than the threshold of 4.

Consider the subsequent example below further illustrating the techniques of the present disclosure in at least one embodiment to shift or redistribute memory pool slice allocation between memory 0 and 1 based on changes in CPU core distribution per socket.

In at least one embodiment, the collective total number of slices, TOTAL, assigned or allocated to a memory pool from both memory 0 (NUMA pool 0) and memory 1 (NUMA pool 1) can remain the same at two different points in time. However, the allocation distribution of the TOTAL slices of the memory pool can vary at the two points in time. For example, at time T1, the CPU core distribution per socket of CPU cores performing flush workflow processing can be (14, 0) as discussed above in connection with the initial CPU core distributions per socket as in FIG. 6. At another point in time T2 after time T1, the CPU core distribution per socket of CPU cores performing flush workflow processing can be (9, 5). Thus although the flush workflow processing has a partition PART1 of 14 CPU cores as both times T1 and T2, the number of CPU cores of each socket performing flush processing is different at the times T1 and T2. In particular, the number of CPU cores of socket 0 performing flush workflow processing has decreased between times T1 to T2, and the number of CPU cores of socket 1 performing flush workflow processing has accordingly increased between times T1 to T2. As a result in at least one embodiment, the TOTAL number of slices assigned to the write cache pool can be redistributed based, at least in part, on the change in CPU core distribution per socket with respect to CPU cores performing flush workflow processing. In the foregoing example, the TOTAL number of slices in the write cache pool can remain the same at times T1 and T2. However, at time T2, the memory pool balancer can release N slices of memory 0 currently allocated to the write cache memory pool and allocate or assign an additional N slices of memory 1 to the write cache memory pool. Thus the memory pool balancer can change the distribution of assigned or allocated slices of memory 0 and memory 1 that are assigned or allocated to the write cache memory pool based, at least in part, on a redistribution, shift or change in quantities of CPU cores of corresponding sockets accessing the write cache memory pool where such CPU cores can perform flush workflow processing. In at least one embodiment, the N slices of memory 0 that are released from the write cache memory pool can be freed and made available for subsequent assignment or allocation to a different memory pool, as may be needed.

More generally in at least one embodiment, the TOTAL number of slices in a memory pool can remain the same at two points in time. However, the proportion or percentage of slices allocated or assigned from memory 0 and memory 1 to the memory pool can change based, at least in part, on the change in quantity of CPU cores of each socket that handle the one or more workflow types that consume or use the memory pool. For example, if the quantity of CPU cores of socket 0 that perform flush workflow processing and thus access or use the write cache memory pool decreases, then the portion or percentage of slices of write cache memory pool from memory 0 can be accordingly decreased. Similarly, if the quantity of CPU cores of socket 1 that perform flush workflow processing and thus access or use the write cache memory pool increases, then the portion or percentage of slices of write cache memory pool from memory 1 can be accordingly increased.

At a third point in time T3 subsequent to T2, the CPU core distribution per socket can be (0,14) with respect to CPU cores handling flush workflow processing. As a result, the TOTAL number of slices in the write data cache can remain the same as at times T1 and T2. However, the portion or percentage of slices of memory 0 and memory 1 assigned or allocated to the write data cache can be modified. In at least one embodiment in response to the CPU core distribution per socket of (0,14) for cores handling flush workflow processing at time T3, the memory pool balancer can perform necessary releasing or freeing of M memory 0 slices from the write data cache and then allocating or assigning an additional M memory 1 slices to the write data cache. In at least one embodiment, the memory pool balancer can, at time T3, perform the foregoing releasing and allocating of slices to the write data cache so that the write data cache only includes slices of memory 1 (e.g., all slices of the write data cache memory pool can be allocated from memory 1 since only CPU cores of socket 0 handle flush workflow processing at time T3) and no slices from memory 0 (e.g., since there are no CPU cores of socket 0 handling flush workflow processing at time T3).

In at least one embodiment, the memory pool balancer can redistribute allocated or assigned slices among memory 0 and memory 1 within a single memory pool if the increase or decrease in quantity of CPU cores of a socket changes by at least a threshold amount. Generally, the threshold can be any suitable size and can vary with embodiment. For example, in connection with the above example with respect to times T1 and T2, a threshold such as 4 can defined such that there is a redistribution or reallocation of slices of the write cache memory pool among memory 0 and memory 1 if the number of CPU cores handling flush processing per socket changes (e.g., either increases or decreases) by more than 4. In the foregoing example, there is a change of 5 in CPU cores handling flush processing, where flush workflow processing for 5 CPU cores has moved from socket 0 to socket 1, and where 5 is above the threshold of 4. Accordingly, the memory pool balancer can accordingly redistribute the proportion or percentage slices of the write data cache based, at least in part, on the CPU core distribution per socket of CPU cores performing flush processing at time T2. From time T1 to time T2, the number of CPU cores of socket 0 handling flush processing decreases by 5 (e.g., from 14 to 9, where the net change of 5 is greater than the threshold of 4). In response, slices of the memory 0 currently allocated to the write cache memory pool can be released. From time T1 to time T2, the number of CPU cores of socket 1 handling flush processing accordingly increases by 5 (e.g., from 0 to 5, where the net change of 5 is greater than the threshold of 4). In response, additional slices of the memory 1 can be allocated to the write cache memory pool, where the number of additional slices allocated can be equal to the number of slices released from memory 0. The slices released from memory 0 can be subsequently allocated and used with a different memory pool, as may be needed.

In a similar manner from time T2 to time T3, there is a change of 9 in CPU cores handling flush processing where flush workflow processing for 9 CPU cores has moved from socket 0 to socket 1, and where 9 is above the threshold of 4. Accordingly, the memory pool balancer can accordingly redistribute the proportion or percentage slices of the write data cache based, at least in part, on the CPU core distribution per socket of CPU cores performing flush processing at time T3. From time T2 to time T3, the number of CPU cores of socket 0 handling flush processing decreases by 9 (e.g., from 9 to 0 where the net change of 9 is greater than the threshold of 4). In response, slices of the memory 0 currently allocated to the write cache memory pool can be released. From time T2 to time T3, the number of CPU cores of socket 1 handling flush processing accordingly increases by 9 (e.g., from 5 to 14, where the net change of 9 is greater than the threshold of 4). In response, additional slices of the memory 1 can be allocated to the write cache memory pool, where the number of additional slices allocated can be equal to the number of slices released from memory 0. The slices released from memory 0 can be subsequently allocated and used with a different memory pool, as may be needed.

In at least one embodiment, a step size denoting the number slices added to or released from a memory pool can be based, at least in part, on the net change or difference in the number of CPU cores per socket between two points in time. In at least one embodiment, the step size denoting the number of slices added can generally increase as the net change in the number of CPU cores per socket increases. In at least one embodiment, the step size denoting the number slices released from a memory pool can generally increase as the net change or difference in the number of CPUs per socket increases.

To further illustrate in connection with the foregoing example, the net change or difference of the number of CPU cores for socket 0 from time T1 to T2 for CPU cores handling flush processing is 5, and the net change or difference of the number of CPU cores for socket 0 from time T2 to T3 for CPU cores handling flush processing is 9. In at least one embodiment, the number of slices of memory 0 released from the write cache memory pool at time T2 can be scaled based, at least in part, on the net change or difference of 5.

In at least one embodiment, the number of slices of memory 0 released from the write cache memory pool at time T2 can be scaled based, at least in part, on the net change or difference of 5; and the number of slices of memory 0 released from the write cache memory pool at time T3 can be scaled based, at least in part, on the net change or difference of 9. In at least one embodiment, the number of slices of memory 1 added to the write cache memory pool at time T2 can be scaled based, at least in part, on the net change or difference of 5; and the number of slices of memory 1 added to the write cache memory pool at time T3 can be scaled based, at least in part, on the net change or difference of 9. Thus in at least one embodiment for example, if 5 slices of memory 0 are released from the write cache memory pool at time T2, based on the above-noted scaling, 9 slices of memory 0 can be released from the write cache memory pool at time T3. Similarly, for example, if 5 slices of memory 1 are added to the write cache memory pool at time T2, based on the above-noted scaling, 9 slices of memory 1 can be added to the write cache memory pool at time T3.

As discussed above in connection with the initial assignment or allocation of slices of memories 0 and 1 to the memory pools, the total number of slices and thus size of each memory pool can be based, at least on part, on the number of CPU cores that handle a particular type of workflow processing using a corresponding memory pool. In a similar manner, the memory pool balancer can also perform processing at various points in time to determine the number of slices in each of the memory pools based, at least in part, on the number of CPU cores that handle the one or more types of workflow processing that access a corresponding memory pool. For example, based on the above with respect to flush workflow processing, the number of CPU cores in the corresponding partition PART1 remains the same at 14 at times T1, T2 and T3. Accordingly the size and TOTAL slices of the write cache memory pool can also remain the same at the times T1, T2 and T3.

As another example, the total number of CPU cores in the corresponding partition PART2 that handles I/O workflow processing can increase from 15 at time T1 to 30 at time T2. In response, the size and TOTAL slices of the data clean cache can accordingly be increased based, at least in part, on the increase in CPU cores from times T1 to T2. Consistent with discussion above in at least one embodiment, the number of CPU cores in PART2 and/or the increase in CPU cores from T1 to T2 can be used as a scaling factor to determine the size (e.g., number of slices) in the write cache memory pool. The increase in CPU cores of PART2 at time T2 can also result in accordingly increasing the size (e.g., number of slices) of the I/O request memory pool that is used by CPU cores performing both flush and I/O workflow processing.

In a similar manner, a decrease in the number of CPU cores in a particular partition can trigger the memory pool balancer to accordingly decrease the size and TOTAL slices of one or more corresponding memory pools used by the CPU cores of the particular partition.

In at least one embodiment, the system, such as the memory pool balancer component, can move slices between different memory pools, that can change in size, such as by releasing memory slices from pools that are detected as underutilized, and allocating additional slices for memory pools which are highly utilized. For example, assume that the flush workflow type has a first CPU core distribution per socket of (14,0) at a point in time T21 and a reduced second CPU core distribution per socket (4,0) at a point in time T22 subsequent to T21. Thus PART1 denoting CPU cores handling flush workflow processing has decreased from 14 cores at time T21 to only 4 cores at time T22. As a result at time T22, the memory pool balancer component may release slices of memory 0 from both the write cache memory pool and the I/O request memory pool since both such memory pools are associated with, and used by, flush CPU cores. (Note that reduction in total flush cores of PART 1 overall from times T21 to time T22 can result in accordingly decreasing the size of the write data cache memory pool and also the I/O request memory pool since both are used by flush cores of PART1 handling flush workflow processing.) The released slices of memory 0 can denote free slices now available for reallocation, such as to other memory pools at time T22 or other subsequent points in time.

Similarly, assume that the I/O workflow type has a third CPU core distribution per socket of (0,15) at time T21 and an increased fourth CPU core distribution per socket (10, 20) at the time T22 subsequent to T21. Thus PART2 denoting CPU cores handling I/O workflow processing has increased or doubled from 15 cores at time T21 to 30 cores at time T22. As a result at time T22, the memory pool balancer component may allocate additional slices of both memory 0 and memory 1 to the corresponding memory pools used by the CPU cores handling I/O workflow processing. For example at time T22, additional slices of memory 0 and memory 1 can be allocated to the data clean cache memory pool; and additional slices of memory 0 and memory 1 can be allocated to the I/O request memory pool since both such memory pools are used by I/O request processing cores. (Note that increase in total flush cores of PART2 overall from times T21 to time T22 results in accordingly increasing the size of the data clean cache memory pool and also the I/O request memory pool since both are used by I/O cores of PART2 handling I/O workflow processing.) In at least one embodiment, at least some of the additional slices of memory 0 allocated at time T22 to the data clean cache memory pool and/or the I/O request memory pool can be those which are released from the flush-related memory pools noted above.

As a result of the foregoing at time T22, the memory pool balancer component can move or shift allocated slices between different memory pools. For example in connection with the above example at time T22, allocated slices of memory 0 can be moved from a source memory pool, such as the write cache memory pool, to a target memory pool, such as the data clean cache memory pool and/or the I/O request memory pool.

In at least one embodiment, such as mentioned above, a threshold can be defined denoting a minimum amount of change in CPU cores per socket that must be reached prior to adding and/or releasing memory slices from a memory pool. Additionally in at least one embodiment, slices can be added and released in defined step sizes as noted above. Further in at least one embodiment, the number of slices of a particular memory (e.g., memory 0) released from or added to a memory pool can be based, at least in part, on the number of CPU cores of a corresponding socket (e.g., socket 0) currently handling one or more workflow types that access the memory pool and/or the amount of change (e.g., increase or decrease) in the number of CPU cores of the corresponding socket currently handling one or more workflow types that access the memory pool.

Based on the foregoing, the techniques of the present disclosure in at least one embodiment improve memory allocation by allocating memory to the various memory pools according to the expected usage of CPU cores on each socket. The techniques of the present disclosure in at least one embodiment provide a method to dynamically move memory between the different pools, in order to optimize the memory allocation according to the current workload requirements of the system. The techniques of the present disclosure in at least one embodiment attempt to first allocate requested memory for structures used by, or associated with, a thread from memory that is local with respect to the CPU core executing the thread. In at least one embodiment, the techniques of the present disclosure can result in reduced memory access times, which will in turn reduce the CPB (cycles per byte), as fewer CPU execution cycles are required for memory access. For example in at least one embodiment, if the direct access time for a CPU core to directly access local memory over a direct connection is 76 ns. (nanoseconds) and the interconnect access time is 140 ns., then using the techniques of the present disclosure may improve the average access time from about 107 ns. (e.g., the average of 76 ns. and 140 ns.) to 76 ns. In at least one embodiment, the techniques of the present disclosure can be used to optimize memory allocation, reduce in memory access times, increase potential maximum memory bandwidth, and accordingly improve the overall system performance.

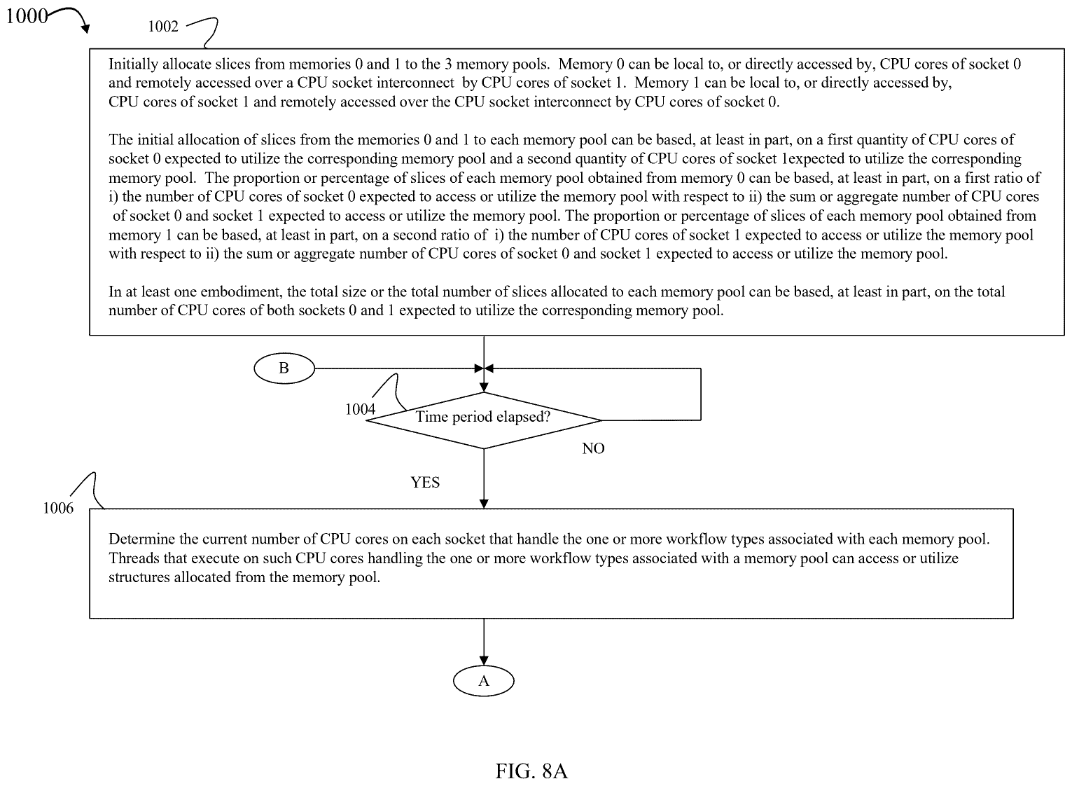

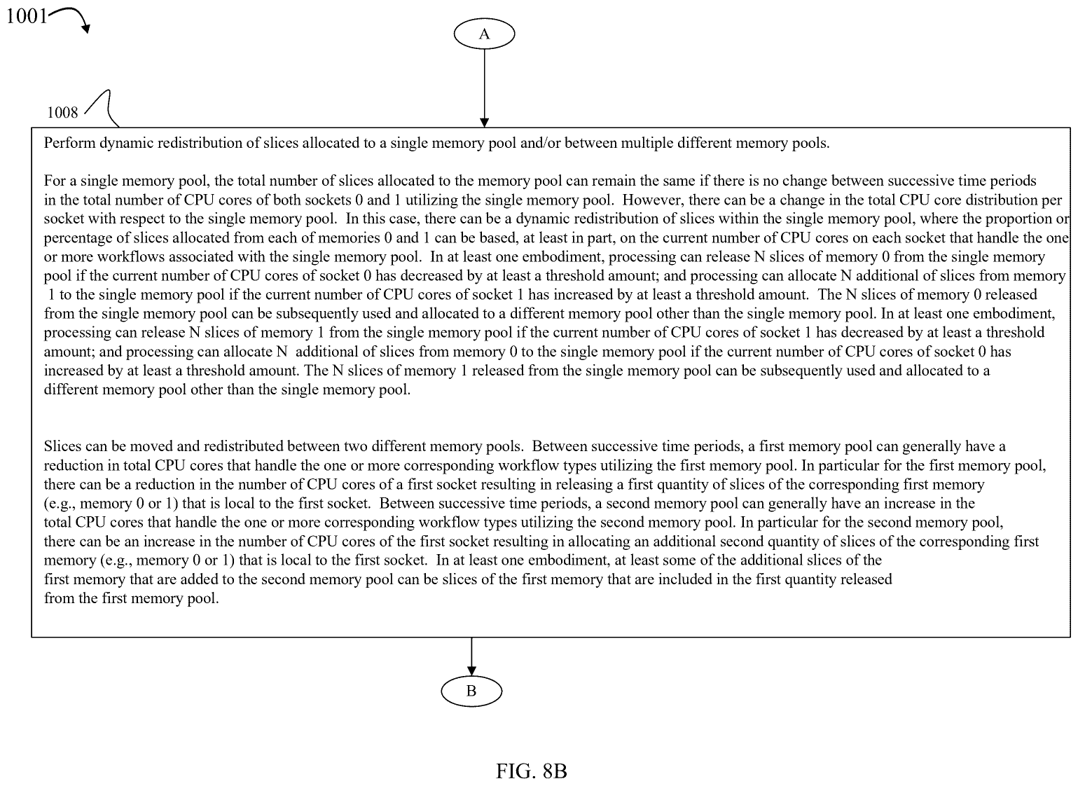

Referring to FIGS. 8A and 8B, shown is a flowchart 1000, 1001 of processing steps that can be performed in at least one embodiment in accordance with the techniques of the present disclosure. The steps of FIGS. 8A and 8B summarize processing discussed above.

At the step 1002, processing can be performed to initially allocate slices from memories 0 and 1 to the 3 memory pools. Memory 0 can be local to, or directly accessed by, CPU cores of socket 0 and remotely accessed over a CPU socket interconnect by CPU cores of socket 1. Memory 1 can be local to, or directly accessed by, CPU cores of socket 1 and remotely accessed over the CPU socket interconnect by CPU cores of socket 0.

The initial allocation of slices from the memories 0 and 1 to each memory pool can be based, at least in part, on a first quantity of CPU cores of socket 0 expected to utilize the corresponding memory pool and a second quantity of CPU cores of socket 1 expected to utilize the corresponding memory pool. The proportion or percentage of slices of each memory pool obtained from memory 0 can be based, at least in part, on a first ratio of i) the number of CPU cores of socket 0 expected to access or utilize the memory pool with respect to ii) the sum or aggregate number of CPU cores of socket 0 and socket 1 expected to access or utilize the memory pool. The proportion or percentage of slices of each memory pool obtained from memory 1 can be based, at least in part, on a second ratio of i) the number of CPU cores of socket 1 expected to access or utilize the memory pool with respect to ii) the sum or aggregate number of CPU cores of socket 0 and socket 1 expected to access or utilize the memory pool.

In at least one embodiment, the total size or the total number of slices allocated to each memory pool can be based, at least in part, on the total number of CPU cores of both sockets 0 and 1 expected to utilize the corresponding memory pool.

In at least one embodiment, the initial allocation of slices to the memory pools can be as discussed, for example, in connection with FIG. 6.

From the step 1002, control proceeds to the step 1004.

At the step 1004, a determination is made as to whether the next time period or cycle has elapsed. If not, control remains at step 1004. If so, control proceeds to the step 1006.

At the step 1006, processing can be performed to determine the current number of CPU cores on each socket that handle the one or more workflow types associated with each memory pool. Threads that execute on such CPU cores handling the one or more workflow types associated with a memory pool can access or utilize structures allocated from the memory pool. In at least one embodiment, the information determined in the step 1006 can be as discussed, for example, in connection with FIG. 7.

From the step 1006, control proceeds to the step 1008.

At the step 1008, dynamic redistribution of slices allocated to a single memory pool and/or between multiple different memory pools can be performed.

For a single memory pool, the total number of slices allocated to the memory pool can remain the same if, between successive time periods or points in time, there is no change in the total number of CPU cores of both sockets 0 and 1 utilizing the single memory pool. However, there can be a change in the total CPU core distribution per socket with respect to the single memory pool. In this case, there can be a dynamic redistribution of slices within the single memory pool, where the proportion or percentage of slices allocated from each of memories 0 and 1 can be based, at least in part, on the current number of CPU cores on each socket that handle the oneor more workflows associated with the single memory pool. In at least one embodiment, processing can release N slices of memory 0 from the single memory pool if the current number of CPU cores of socket 0 has decreased by at least a threshold amount; and processing can allocate N additional of slices from memory 1 to the single memory pool if the current number of CPU cores of socket 1 has increased by at least a threshold amount. The N slices of memory 0 released from the single memory pool can be subsequently used and allocated to a different memory pool other than the single memory pool. In at least one embodiment, processing can release N slices of memory 1 from the single memory pool if the current number of CPU cores of socket 1 has decreased by at least a threshold amount; and processing can allocate N additional of slices from memory 0 to the single memory pool if the current number of CPU cores of socket 0 has increased by at least a threshold amount. The N slices of memory 1 released from the single memory pool can be subsequently used and allocated to a different memory pool other than the single memory pool.

Slices can be moved and redistributed between two different memory pools. Between two time periods or points in time, a first memory pool can generally have a reduction in total CPU cores that handle the one or more corresponding workflow types utilizing the first memory pool. In particular for the first memory pool, there can be a reduction in the number of CPU cores of a first socket resulting in releasing a first quantity of slices of the corresponding first memory (e.g., memory 0 or 1) that is local to the first socket. Between the two successive time periods or points in time, a second memory pool can generally have an increase in the total CPU cores that handle the one or more corresponding workflow types utilizing the second memory pool. In particular for the second memory pool, there can be an increase in the number of CPU cores of the first socket resulting in allocating an additional second quantity of slices of the corresponding first memory (e.g., memory 0 or 1) that is local to the first socket. In at least one embodiment, at least some of the additional slices of the first memory that are added to the second memory pool can be slices of the first memory that are included in the first quantity released from the first memory pool.

In at least one embodiment, such as mentioned above, a threshold can be defined denoting a minimum amount of change in CPU cores per socket that must be reached prior to adding and/or releasing memory slices from a memory pool. Additionally in at least one embodiment, slices can be added and released in defined step sizes as noted above. Further in at least one embodiment, the number of slices of a particular memory (e.g., memory 0) released from or added to a memory pool can be based, at least in part, on the number of CPU cores of a corresponding socket (e.g., socket 0) currently handling one or more workflow types that access the memory pool and/or the amount of change (e.g., increase or decrease) in the number of CPU cores of the corresponding socket currently handling one or more workflow types that access the memory pool.

From the step 1008, control can return to the step 1004.

The techniques described in the present disclosure can be performed by any suitable hardware and/or software. For example, techniques herein can be performed by executing code which is stored on any one or more different forms of computer-readable media, where the code is executed by one or more processors, for example, such as processors of a computer or other system, an ASIC (application specific integrated circuit), and the like. Computer-readable media includes different forms of volatile (e.g., RAM) and non-volatile (e.g., ROM, flash memory, magnetic or optical disks, or tape) storage, where such storage includes be removable and non-removable storage media.

While the present disclosure provides various embodiments shown and described in detail, their modifications and improvements will become readily apparent to those skilled in the art. It is intended that the specification and examples be considered as exemplary only with the true scope and spirit of the present disclosure indicated by the following claims.

What is claimed is:

1. A computer-implemented method comprising:
performing, at a first point in time, an initial allocation of memory slices for a plurality of memory pools from a first memory and a second memory, wherein the first memory is i) local to, and directly accessed by, CPU cores of a first socket and ii) remotely accessed by CPU cores of a second socket, and wherein the second memory is i) local to, and directly accessed by, CPU cores of the second socket and ii) remotely accessed by CPU cores of the first socket, wherein the initial allocation of memory slices from the first memory and the second memory for each of the plurality of memory pools is based, at least in part, on first information including: i) a first quantity of CPU cores of the first socket that handle one or more workflow types associated with said each memory pool and that utilize said each memory pool and ii) a second quantity of CPU cores of the second socket that handle one or more workflow types associated with said each memory pool and that utilize said each memory pool;
determining second information at a second point in time subsequent to the first point in time, wherein the second information includes, for each of the plurality of memory pools at the second point in time, i) a third quantity of CPU cores of the first socket that handle one or more workflow types associated with said each memory pool and that utilize said each memory pool, and ii) a fourth quantity of CPU cores of the second socket that handle one or more workflow types associated with said each memory pool and that utilize said each memory pool;
determining one or more changes between corresponding quantities of CPU cores of the first information and the second information for any of the first socket and the second socket for one or more of the plurality of memory pools; and
performing dynamic redistribution of memory slices of the one or more memory pools based, at least in part, on the one or more changes.

2. The computer-implemented method of claim 1, wherein said performing dynamic redistribution of memory slices includes performing first processing to dynamically redistribute allocated memory slices of a single memory pool by modifying corresponding proportions of memory slices allocated from each of the first memory and the second memory based, at least in part, on a first change in a number of CPU cores of any of the first socket and the second socket that handles one or more workflow types associated with said single memory pool and that utilize said single memory pool, wherein the single memory pool is included in the one or more memory pools, and wherein the first change is included in the one or more changes.

3. The computer-implemented method of claim 2, wherein, at both the first point in time and the second point in time, the single memory pool has a same first total of CPU cores of the first socket and the second socket which handle corresponding one or more workflow types associated with said single memory pool and utilize said single memory pool.

4. The computer-implemented method of claim 3, wherein the first change denotes an increase of a first amount between the first quantity of CPU cores of the first socket at the first point in time and the third quantity of CPU cores of the first socket at the second point in time, and wherein the first change denotes a decrease of the first amount between the second quantity of CPU cores of the second socket at the first point in time and the fourth quantity of CPU cores of the second socket at the second point in time.

5. The computer-implemented method of claim 4, wherein the first processing includes:
determining whether the first amount exceeds a specified threshold amount of difference; and
responsive to determining that the first amount exceeds the specified threshold of difference, performing second processing including:
releasing a first number of memory slices of the single memory pool where each of the first number of slices is included in the second memory local to the second socket; and
allocating, from the first memory local to the first socket, the first number of additional memory slices for the single memory pool.

6. The computer-implemented method of claim 5, wherein the first processing includes:
responsive to determining that the first amount does not exceed the specified threshold of difference, determining not to dynamically redistribute allocated memory slices of the single memory pool.

7. The computer-implemented method of claim 5, wherein the second processing is performed and the first number of slices released from the second memory are subsequently reallocated to a second of the plurality of memory pools.

8. The computer-implemented method of claim 3, wherein the first change denotes a decrease of a first amount between the first quantity of CPU cores of the first socket at the first point in time and the third quantity of CPU cores of the first socket at the second point in time, and wherein the first change denotes an increase of the first amount between the second quantity of CPU cores of the second socket at the first point in time and the fourth quantity of CPU cores of the second socket at the second point in time.

9. The computer-implemented method of claim 8, wherein the first processing includes:
determining whether the first amount exceeds a specified threshold amount of difference; and
responsive to determining that the first amount exceeds the specified threshold of difference, performing second processing including:
releasing a first number of memory slices of the single memory pool where each of the first number of slices is included in the first memory local to the first socket; and
allocating, from the second memory local to the second socket, the first number of additional memory slices for the single memory pool.

10. The computer-implemented method of claim 9, wherein the first processing includes:
responsive to determining that the first amount does not exceed the specified threshold of difference, determining not to dynamically redistribute allocated memory slices of the single memory pool.

11. The computer-implemented method of claim 9, wherein the second processing is performed and the first number of slices released from the second memory are subsequently reallocated to a second of the plurality of memory pools.

12. The computer-implemented method of claim 1, wherein said performing dynamic redistribution of memory slices includes performing first processing to dynamically redistribute allocated memory slices of any of the first memory and the second memory between a first memory pool and a second memory pool, wherein the first memory pool and the second memory pool are included in the one or more memory pools.

13. The computer-implemented method of claim 12, wherein the one or more changes include a first reduction, between the first point in time and the second point in time, in CPU cores of the first socket that handle one or more workflow types associated with the first memory pool and that utilize the first memory pool, wherein the first reduction is determined as a difference between one of the respective first quantities of the first information and one of the respective third quantities of the second information corresponding to the first memory pool.

14. The computer-implemented method of claim 13, wherein the first processing includes:
releasing, from the first memory pool, a first number of memory slices of the first memory thereby making the first number of memory slices available for reuse and reallocation to another memory pool.

15. The computer-implemented method of claim 14, wherein the one or more changes includes a first increase, between the first point in time and the second point in time, in CPU cores of the first socket that handle one or more workflow types associated with the second memory pool and that utilize the second memory pool, wherein the first increase is determined as a difference between one of the respective first quantities of the first information and one of the respective third quantities of the second information corresponding to the second memory pool.

16. The computer-implemented method of claim 15, wherein the first processing includes:
adding, to the second memory pool, a second number of memory slices of the first memory, wherein one or more of the second number of memory slices is included in the first number of memory slices released from the first memory pool.

17. The computer-implemented method of claim 16, wherein the first number of memory slices released from the first memory pool is based, at least in part, on the respective third quantity of the second information corresponding to the first memory pool, and wherein the second number of memory slices added to the second memory pool is based, at least in part, on the respective third quantity of the second information corresponding to the second memory pool.

18. The computer-implemented of claim 1, further comprising:
prior to performing said initial allocation of memory slices at the first point in time, determining a plurality of partitions of CPU cores for the plurality of memory pools, wherein each of the plurality of memory pools is associated with a corresponding one of the plurality of partitions, where CPU cores of said corresponding one partition are used exclusively for handling one or more workflow types that are associated with said each memory pool and that access said each memory pool, and
wherein, for each of the plurality of memory pools, the corresponding one of the plurality of partitions has a total number of CPU cores equal to a sum of a respective one of the first quantities and a respective one of the second quantities corresponding to said each memory pool.

19. A system comprising:
one or more processors; and
one or more memories comprising code stored thereon that, when executed, performs a method comprising:
performing, at a first point in time, an initial allocation of memory slices for a plurality of memory pools from a first memory and a second memory, wherein the first memory is i) local to, and directly accessed by, CPU cores of a first socket and ii) remotely accessed by CPU cores of a second socket, and wherein the second memory is i) local to, and directly accessed by, CPU cores of the second socket and ii) remotely accessed by CPU cores of the first socket, wherein the initial allocation of memory slices from the first memory and the second memory for each of the plurality of memory pools is based, at least in part, on first information including: i) a first quantity of CPU cores of the first socket that handle one or more workflow types associated with said each memory pool and that utilize said each memory pool and ii) a second quantity of CPU cores of the second socket that handle one or more workflow types associated with said each memory pool and that utilize said each memory pool;
determining second information at a second point in time subsequent to the first point in time, wherein the second information includes, for each of the plurality of memory pools at the second point in time, i) a third quantity of CPU cores of the first socket that handle one or more workflow types associated with said each memory pool and that utilize said each memory pool, and ii) a fourth quantity of CPU cores of the second socket that handle one or more workflow types associated with said each memory pool and that utilize said each memory pool;
determining one or more changes between corresponding quantities of CPU cores of the first information and the second information for any of the first socket and the second socket for one or more of the plurality of memory pools; and
performing dynamic redistribution of memory slices of the one or more memory pools based, at least in part, on the one or more changes.

20. One or more non-transitory computer-readable media comprising code stored thereon that, when executed, performs a method comprising:
performing, at a first point in time, an initial allocation of memory slices for a plurality of memory pools from a first memory and a second memory, wherein the first memory is i) local to, and directly accessed by, CPU cores of a first socket and ii) remotely accessed by CPU cores of a second socket, and wherein the second memory is i) local to, and directly accessed by, CPU cores of the second socket and ii) remotely accessed by CPU cores of the first socket, wherein the initial allocation of memory slices from the first memory and the second memory for each of the plurality of memory pools is based, at least in part, on first information including: i) a first quantity of CPU cores of the first socket that handle one or more workflow types associated with said each memory pool and that utilize said each memory pool and ii) a second quantity of CPU cores of the second socket that handle one or more workflow types associated with said each memory pool and that utilize said each memory pool;
determining second information at a second point in time subsequent to the first point in time, wherein the second information includes, for each of the plurality of memory pools at the second point in time, i) a third quantity of CPU cores of the first socket that handle one or more workflow types associated with said each memory pool and that utilize said each memory pool, and ii) a fourth quantity of CPU cores of the second socket that handle one or more workflow types associated with said each memory pool and that utilize said each memory pool;
determining one or more changes between corresponding quantities of CPU cores of the first information and the second information for any of the first socket and the second socket for one or more of the plurality of memory pools; and
performing dynamic redistribution of memory slices of the one or more memory pools based, at least in part, on the one or more changes.
